(19) United States
(12) Patent Application Publication
(10) Pub. No.: US 2016/0155129 A1
(43) Pub. Date: Jun. 2, 2016

(54) INFORMATION PROCESSING SYSTEM, SERVER SYSTEM, AND INFORMATION PROCESSING APPARATUS

(71) Applicants: Hiroaki ONO, Kanagawa (JP); Atsushi FUKUZUMI, Kanagawa (JP)

(72) Inventors: Hiroaki ONO, Kanagawa (JP); Atsushi FUKUZUMI, Kanagawa (JP)

(73) Assignee: RICOH COMPANY, LTD., Tokyo (JP)

(21) Appl. No.: 14/943,172

(22) Filed: Nov. 17, 2015

(30) Foreign Application Priority Data
Dec. 2, 2014 (JP) 2014-243649

(51) Int. Cl. G06Q 30/00; G06Q 30/02

(52) U.S. Cl. CPC G06Q 30/01; G06Q 30/0202

(57) ABSTRACT

An information processing apparatus includes an acquiring unit configured to acquire information relating to a target used by a customer with which an administrator has not made contact for a predetermined period; a determining unit configured to determine a target that matches a condition of replacement prediction, from among the targets of which the relating information has been acquired by the acquiring unit; a generating unit configured to generate proposal support information including the information relating to the target, with respect to the target that has been determined to match the condition by the determining unit; and a report unit configured to send a report that enables acquisition of the proposal support information including the information relating to the target, to the administrator managing the target that has been determined to match the condition by the determining unit.

### BACKGROUND OF THE INVENTION

1. Field of the Invention

The present invention relates to an information processing system, a server system, and an information processing apparatus.

2. Description of the Related Art

Generally, a device such as an image forming apparatus is managed by an administrator (for example, a salesperson, a maintenance person, etc.) even after being delivered to the customer, and is replaced according to the customer's needs and used permanently. The timing of replacing the device, which is the target of management, differs according to the customer, and the administrator performs sales activities with respect to the customer to make efforts so as not to lose any opportunities of replacement.

However, when there are a huge number of targets to be managed, it is difficult to perform sales activities at appropriate timings for all of the customers.

Furthermore, even when sales activities are performed at appropriate timings, if proposals according to the needs of the customers are not made, the customers may switch to devices of other companies, which leads to losing opportunities of replacement by customers.

Patent Document 1: Japanese Laid-Open Patent Publication No. 2004-287874

### SUMMARY OF THE INVENTION

The present invention provides an information processing system, a server system, and an information processing apparatus, in which one or more of the above-described disadvantages are eliminated.

According to an aspect of the present invention, there is provided an information processing apparatus including an acquiring unit configured to acquire information relating to a target used by a customer with which an administrator has not made contact for a predetermined period; a determining unit configured to determine a target that matches a condition of replacement prediction, from among the targets of which the relating information has been acquired by the acquiring unit; a generating unit configured to generate proposal support information including the information relating to the target, with respect to the target that has been determined to match the condition by the determining unit; and a report unit configured to send a report that enables acquisition of the proposal support information including the information relating to the target, to the administrator managing the target that has been determined to match the condition by the determining unit.

According to an aspect of the present invention, there is provided a server system including a plurality of server devices for implementing various functions of the server system, the server system including an acquiring unit configured to acquire information relating to a target used by a customer with which an administrator has not made contact for a predetermined period; a determining unit configured to determine a target that matches a condition of replacement prediction, from among the targets of which the relating information has been acquired by the acquiring unit; a generating unit configured to generate proposal support information including the information relating to the target, with respect to the target that has been determined to match the condition by the determining unit; and a report unit configured to send a report that enables acquisition of the proposal support information including the information relating to the target, to the administrator managing the target that has been determined to match the condition by the determining unit.

According to an aspect of the present invention, there is provided an information processing system including a server device; and an information terminal communicatively connected to the server device, wherein the server device includes an acquiring unit configured to acquire information relating to a target used by a customer with which an administrator has not made contact for a predetermined period, a determining unit configured to determine a target that matches a condition of replacement prediction, from among the targets of which the relating information has been acquired by the acquiring unit, a generating unit configured to generate proposal support information including the information relating to the target, with respect to the target that has been determined to match the condition by the determining unit, and a report unit configured to send a report that enables acquisition of the proposal support information including the information relating to the target, to the administrator managing the target that has been determined to match the condition by the determining unit, and wherein the information terminal includes an output unit configured to read, from the server device, the proposal support information including the information relating to the target that has been determined to match the condition by the determining unit, the proposal support information being read based on the report sent by the report unit.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of the overall configuration of a support system;

FIG. 2 illustrates an overview of functions implemented in the support system;

FIG. 3 illustrates a hardware configuration of a data analysis server;

FIG. 4 illustrates an example of replacement logic information;

FIG. 5 illustrates an example of model selection logic information;

FIG. 6 illustrates a functional configuration of a data analysis server;

FIG. 7 is a sequence diagram illustrating a flow of a logic construction phase in the support process executed by the support system;

FIG. 8 is a sequence diagram illustrating a flow of an alert execution phase in the support process executed by the support system;

FIG. 9 is a flowchart indicating a flow of a replacement logic generation process;

FIG. 10 is a flowchart indicating a flow of a model selection logic generation process;

FIG. 11 is a flowchart indicating a flow of a replacement device determination process;

FIG. 12 is a flowchart indicating a flow of a model determination process;

FIG. 13 illustrates an example of a performance comparison table;

FIG. 14 is a flowchart indicating a flow of a usage tendency determination process;

FIG. 15 illustrates an example of a usage record;

FIGS. 16A and 16B illustrate examples of graphs of waveforms in the past 24 months of the usage record and comments;

FIG. 17 is a flowchart indicating a flow of a sheet generation process;

FIG. 18 illustrates an example of jam occurrence history information;

FIG. 19 illustrates an example of repair record information;

FIG. 20 illustrates an example of a sheet (proposal support information);

FIG. 21 is a flowchart indicating a flow of a report process;

FIG. 22 illustrates an example of a list of priority sales target image forming apparatuses;

FIG. 23 illustrates an overview of functions provided in the support system;

FIG. 24 illustrates an example of a sheet (proposal support information); and

FIG. 25 illustrates the basic principle of an information processing system.

### DETAILED DESCRIPTION OF THE PREFERRED EMBODIMENTS

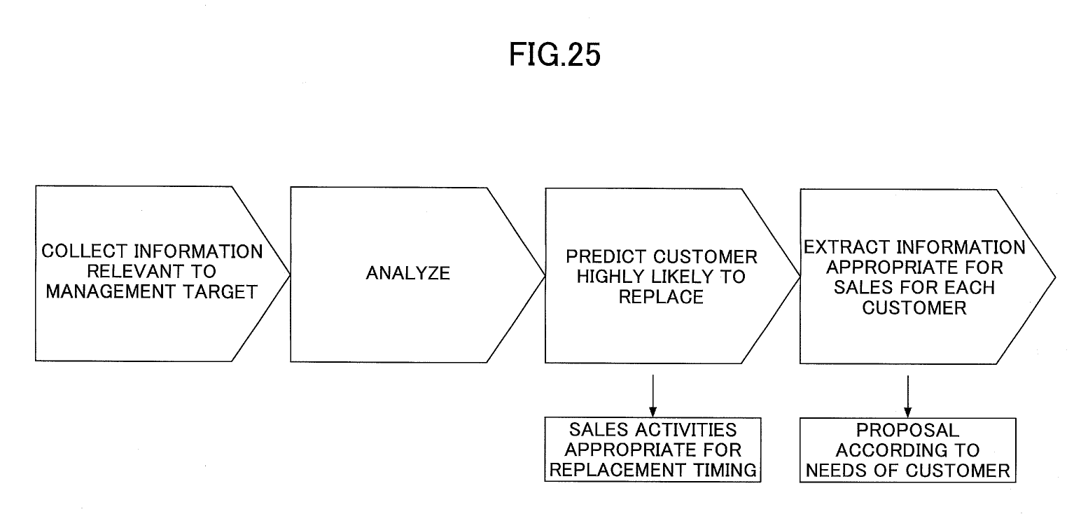

First, a description is given of the basic principle of an information processing system according to an embodiment of the present invention. FIG. 25 illustrates the basic principle of an information processing system according to an embodiment.

As illustrated in FIG. 25, the information processing system according to an embodiment collects all sorts of information items relevant to the targets of management, and analyzes the information to predict a customer who is highly likely to replace the target. Accordingly, it is possible to prioritize sales activities for the customers that are highly likely to replace the target, and realize sales activities at appropriate timings for replacement.

Furthermore, the information processing system according to an embodiment extracts information appropriate for sales activities for a customer who is highly likely to replace the target, from the collected information. Accordingly, it is possible to recognize the needs of customers when replacing the target, and realize proposals according to the customers' needs.

As a result, by the information processing system according to an embodiment, it is possible to support the sales activities when replacing targets.

A description is given, with reference to the accompanying drawings, of embodiments of the present invention. Note that in the descriptions of the embodiments in the specification and drawings, the elements having substantially the same functions are denoted by the same reference numerals and overlapping descriptions are omitted. Note that as a matter of convenience, the information processing system is referred to as a “support system”.

### First Embodiment

### <1. Overall Configuration of Support System>

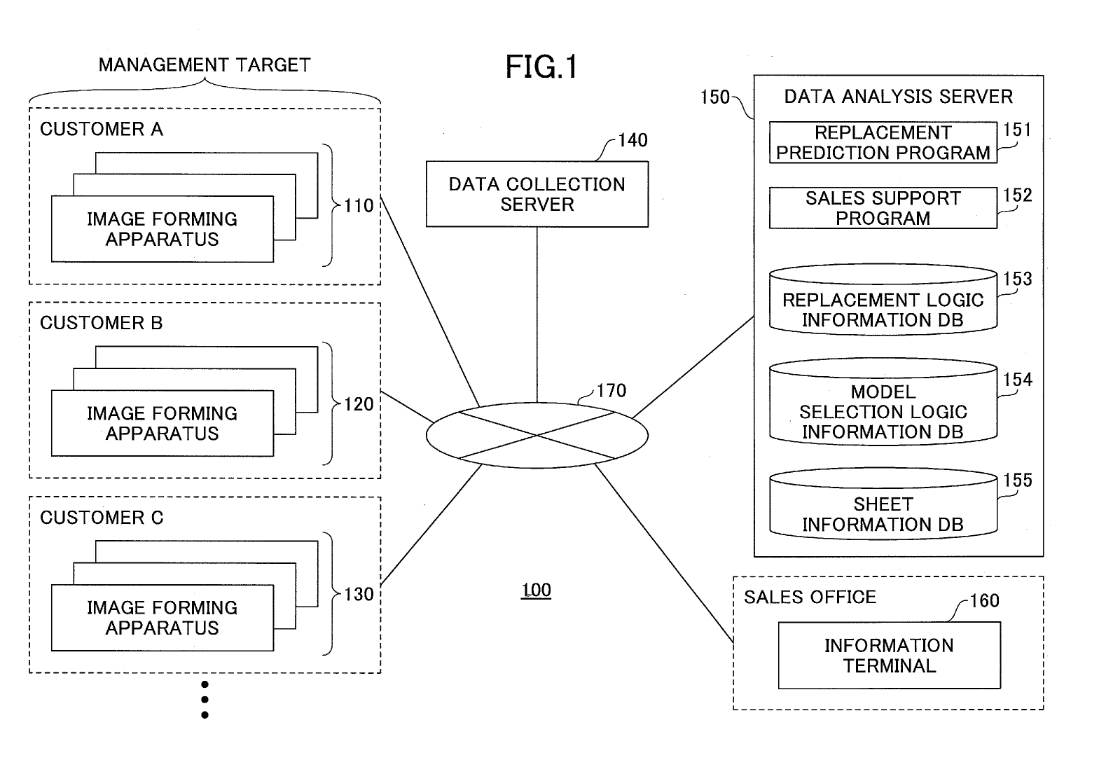

First, a description is given of the overall configuration of a support system 100 for supporting sales activities by an administrator (described as a salesperson in the present embodiment) managing the targets of management. FIG. 1 illustrates an example of the overall configuration of the support system 100.

As illustrated in FIG. 1, the support system 100 according to the present embodiment includes a plurality of image forming apparatuses included in each of the image forming apparatus groups 110, 120, 130, and so on, as management targets managed by the salesperson. Furthermore, the support system 100 includes a data collection server 140, a data analysis server (information processing apparatus) 150, and an information terminal 160. The plurality of image forming apparatuses included in each of the image forming apparatus groups 110, 120, 130, and the data collection server 140 are communicatively connected to each other via a network 170. Similarly, the data analysis server 150, the data collection server 140, and the information terminal 160 are communicatively connected to each other via the network 170.

The image forming apparatus groups 110, 120, 130, and so on are respectively used by a customer A, a customer B, a customer C, and so on. In the present embodiment, the plurality of image forming apparatuses included in each of the image forming apparatus groups 110, 120, 130, and so on are assumed to be, for example, MFPs (Multi-function peripherals) having a copy function, a print function, a fax function, a scanner function, etc.

The data collection server 140 collects any information relevant to the image forming apparatuses managed by the salesperson (hereinafter, the information collected by the data collection server 140 is referred to as “collection information”).

The data analysis server 150 is a device for analyzing the collection information collected by the data collection server 140. In the data analysis server 150, a replacement prediction program 151 and a sales support program 152 are installed. Furthermore, in the data analysis server 150, a replacement logic information DB 153, a model selection logic information DB 154, and a sheet information DB 155 are stored.

The information terminal 160 is a terminal that is operated by the salesperson, and is installed in, for example, the sales office to which the salesperson belongs. However, the information terminal 160 may be a mobile terminal. The information terminal 160 can access the sheet information DB 155 in the data analysis server 150.

Note that in the example of FIG. 1, each of the data collection server 140 and the data analysis server 150 is a single server device; however, the data collection server 140 and the data analysis server 150 may be a server system including a plurality of server devices.

Furthermore, in FIG. 1, as a matter of convenience, the information terminal 160 operated only by a particular salesperson of a particular sales office is illustrated; however, it is assumed that there are a plurality of sales offices and salespersons, and that the information terminals operated by the respective salespersons are included in the support system 100.

### <2. Overview of Functions Implemented in Support System>

Next, a description is given of an overview of functions implemented in the support system 100. In the support system 100, image forming apparatuses that are highly likely to be replaced by customer A, customer B, customer C, and so on, are extracted from the image forming apparatuses managed by the salesperson. Furthermore, when an image forming apparatus that is highly likely to be replaced is extracted, this is reported to the salesperson. Also, when the salesperson performs sales activities for the customer using the extracted image forming apparatus, material by which the salesperson can make a proposal according to the customer's needs is generated, and the material is provided to the salesperson. Note that in the following, an example of proposal support information, which is used when the salesperson performs sales activities for the customer, and by which a proposal according to the customer's needs can be made, is referred to as a “sheet”.

By these functions (hereinafter, “replacement prediction function” and “sales support function”) implemented in the support system 100, the salesperson can visit the customer at an appropriate timing for replacement, and make a proposal according to the customer's needs. That is, according to the support system 100, it is possible to support the sales activities by the salesperson, at the time of replacement of an image forming apparatus managed by the salesperson.

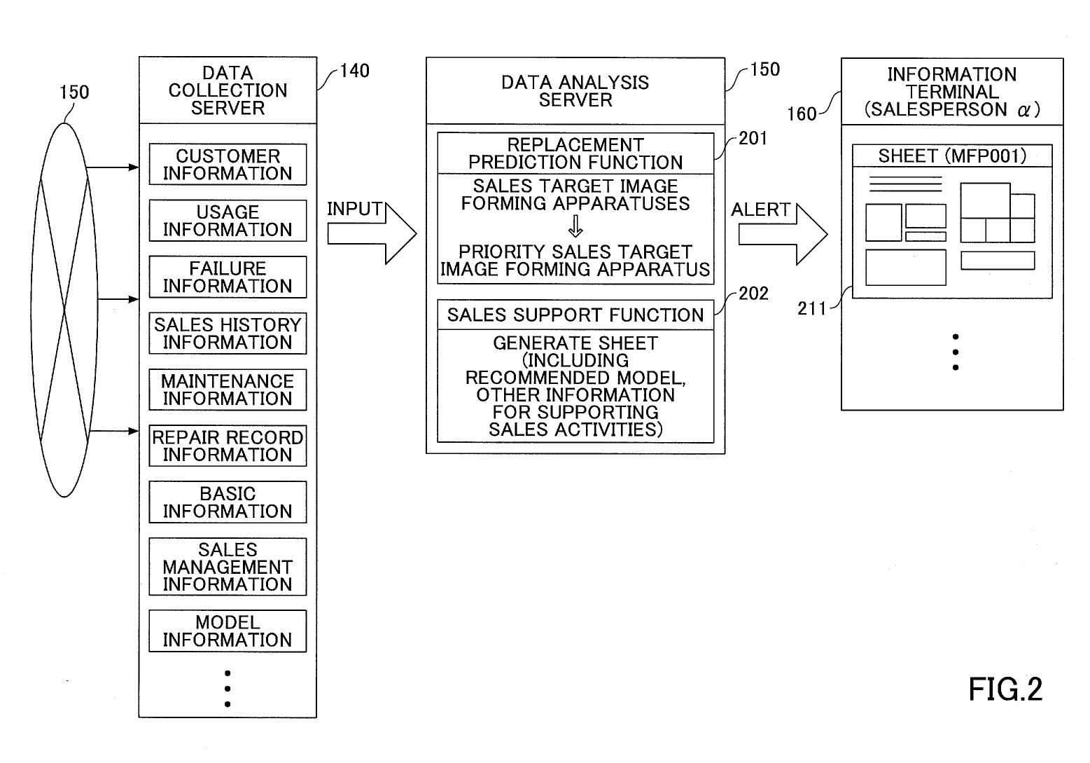

FIG. 2 illustrates an overview of functions implemented in the support system 100. As illustrated in FIG. 2, for implementing the replacement prediction function and the sales support function, the data collection server 140 collects collection information. The collection information collected by the data collection server 140 includes, for example, customer information, usage information, failure information, sales history information, maintenance information, repair record information, basic information, sales management information, model information, etc.

The customer information includes any kind of information relevant to the customer, ranging from general information such as the name and location (address) of the customer, the business scale, number of employees, etc., to information indicating the financial conditions such as the sales, the current profits, etc.

The usage information includes information relevant to the usage record of the image forming apparatus (number of copy sheets, number of two-color copy sheets, number of print sheets, number of two-color print sheets, number of fax receptions, number of fax transmissions, number of scanner inputs, etc.). The information relevant to the usage record is collected as, for example, the monthly record data during a predetermined past period.

The failure information includes information relevant to the failure record in the image forming apparatus and information relevant to the occurrence of paper jams. The information relevant to the failure record is collected as, for example, the monthly record data during a predetermined past period. Furthermore, the information relevant to the occurrence of paper jams is collected as, for example, compiled statistical data divided into data indicating the location where the paper jam has occurred and the time period when the paper jam has occurred.

The sales history information includes any kind of information relevant to the sales record by the salesperson, such as the time and date when the salesperson has visited the customer, the number of times the salesperson has visited the customer, the duration of the interview, the time and date when the salesperson has performed sales activities by telephone, the number of times the salesperson has performed sales activities by telephone, the duration of the telephone call, etc.

The maintenance information includes any kind of information relevant to the maintenance record, such as the time and date when the maintenance person has performed maintenance on the image forming apparatus, the number of times the maintenance person has performed maintenance on the image forming apparatus, etc.

The repair record information includes any kind of information relevant to the repair record, such as the time taken for repair when the maintenance person has repaired a failed image forming apparatus, information relevant to the replaced parts, etc.

The basic information includes any kind of information that is determined when the image forming apparatus is delivered, such as the customer name and the business office name of the customer A, customer B, customer C, and so on, the location (address) of the business office, the delivery date of each image forming apparatus, the device ID of the delivered image forming apparatus, the contract form (rental or purchase), etc.

The sales management information includes information indicating the correspondence relationship between the salesperson, the image forming apparatus that is the management target managed by the salesperson, and the customer using the image forming apparatus.

The model information includes information relevant to the performance, etc., of all models of image forming apparatuses handled by the salesperson.

Note that the collection information illustrated in FIG. 2 is merely one example of information collected by the data collection server 140; information other than the collection information illustrated in FIG. 2 may be collected. However, the information collected by the data collection server 140 preferably includes information relevant to the financial conditions of the customer, information indicating the importance degree of the image forming apparatus, and information relevant to brand loyalty. This is because these kinds of information are effective in improving the performance of the replacement prediction function.

For example, even when there is a need to replace the image forming apparatus, if the customer does not have the financial conditions for making equipment investment possible, the possibility of replacement is decreased. Furthermore, when the failure frequency of the image forming apparatus increases and the downtime becomes long, the possibility of replacement would be increased if the corresponding image forming apparatus is indispensable for business execution for the customer; however, if the importance degree of the corresponding image forming apparatus is low, the possibility of replacement would not be increased. Furthermore, in the case of a customer who has high brand loyalty and continuously uses the image forming apparatuses of a certain company, the possibility of replacing the image forming apparatus with an image forming apparatus of the certain company is high; however, in the case of a customer who has low brand loyalty, the customer may switch to an image forming apparatus of another company.

In the data analysis server 150, the collection information collected by the data collection server 140 is used to realize a replacement prediction function 201 and a sales support function 202. In the data analysis server 150, parameters that are effective for realizing the replacement prediction function 201 and the sales support function 202 are extracted from the huge amount of collection information collected by the data collection server 140. Then, based on an optimum combination of the parameters, the replacement prediction function 201 and the sales support function 202 are realized.

The replacement prediction function 201 identifies an image forming apparatus used by a customer with which the salesperson has not made contact for a predetermined period, from among the image forming apparatuses that are management targets managed by the salesperson. With respect to the customer using the identified image forming apparatus, the salesperson should be performing sales activities, and therefore the corresponding image forming apparatus is hereinafter referred to as an “sales target image forming apparatus”. Note that a customer with which the salesperson has not made contact for a predetermined period, means a customer with which the salesperson, etc., has not made any contact through communication by dialogue for a predetermined period. A customer with which the salesperson has not made any contact through communication by dialogue includes, for example, a customer that the salesperson has not accessed by visiting the customer, and a customer that the salesperson has not accessed by various media such as the telephone, direct mail, the Internet, etc. Furthermore, a customer that the maintenance person has not accessed by visiting or through various media, may be included (that is, it is assumed that an administrator includes one of or both of a salesperson and a maintenance person).

Furthermore, the replacement prediction function 201 extracts an image forming apparatus that is highly likely to be replaced, from among the sales target image forming apparatuses. The salesperson is supposed to prioritize sales activities for a customer who is using an image forming apparatus that is highly likely to be replaced, and therefore an image forming apparatus that is highly likely to be replaced extracted from the sales target image forming apparatuses, is hereinafter referred to as a “priority sales target image forming apparatus”.

The sales support function 202 creates a sheet for supporting sales activities of the salesperson, for each of the extracted priority sales target image forming apparatuses. The sheet includes the recommended model when replacing the priority sales target image forming apparatus, record information unique to the corresponding image forming apparatus (usage information, failure information, maintenance information, repair record information, etc.), and other information such as basic information and model information.

Furthermore, when the priority sales target image forming apparatus is extracted, the sales support function 202 sends a report indicating that the priority sales target image forming apparatus has been extracted (sending an alert), addressed to the salesperson managing the corresponding image forming apparatus. By receiving an alert, the salesperson (salesperson α in the example of FIG. 2) recognizes the customer for which sales activities are to be prioritized. Furthermore, by accessing the data analysis server 150 via the information terminal 160, the salesperson α can read and output a sheet 211. That is, by the transmission of an alert, the salesperson α becomes capable of acquiring the sheet 211. As a result, the salesperson can perform sales activities while viewing the sheet 211.

### <3. Hardware Configuration of Data Analysis Server>

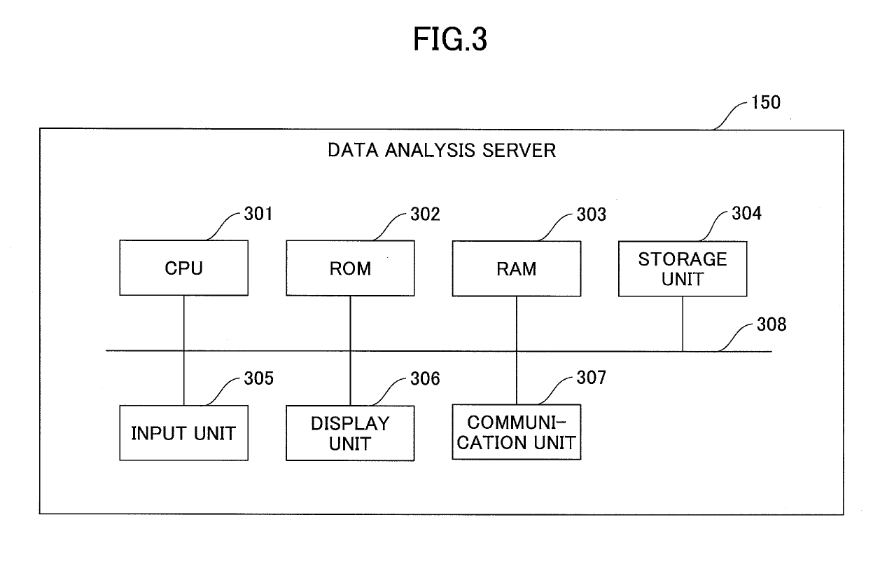

Next, a description is given of a hardware configuration of the data analysis server 150. FIG. 3 illustrates a hardware configuration of the data analysis server 150.

As illustrated in FIG. 3, the data analysis server 150 includes a CPU (Central Processing Unit) 301, a ROM (Read Only Memory) 302, a RAM (Random Access Memory) 303, and a storage unit 304. Furthermore, the data analysis server 150 includes an input unit 305, a display unit 306, and a communication unit 307. The respective units of the data analysis server 150 are interconnected by a bus 308.

The CPU 301 is a computer that executes various programs (for example, the replacement prediction program 151 and the sales support program 152) stored in the storage unit 304.

The ROM 302 is a non-volatile memory. The ROM 302 stores various programs and data, etc., needed by the CPU 301 for executing various programs stored in the storage unit 304. Specifically, the ROM 302 stores boot programs such as BIOS (Basic Input/Output System), EFI (Extensible Firmware Interface), etc.

The RAM 303 is a main storage such as DRAM (Dynamic Random Access Memory), SRAM (Static Random Access Memory), etc. The RAM 303 functions as a work area that is expanded when the CPU 301 executes various programs stored in the storage unit 304.

The storage unit 304 stores various programs executed by the CPU 301 and various DBs used when the CPU 301 executes various programs. Note that various DBs include, for example, the replacement logic information DB 153, the model selection logic information DB 154, the sheet information DB 155, etc.

The input unit 305 is an interface for inputting various kinds of information in the data analysis server 150. The display unit 306 displays various kinds of information of the data analysis server 150.

The communication unit 307 performs communication with the data collection server 140 and the information terminal 160 via the network 170.

Note that the hardware configurations of the data collection server 140 and the information terminal 160 are substantially the same as the hardware configuration of the data analysis server 150. Thus, descriptions of the hardware configurations of the data collection server 140 and the information terminal 160 are omitted.

### <4. Description of Information Stored in DBs>

Next, a description is given of various kinds of information stored in the replacement logic information DB 153 and the model selection logic information DB 154 among the DBs of the data analysis server 150.

### <4.1 Replacement Logic Information Stored in Replacement Logic Information DB>

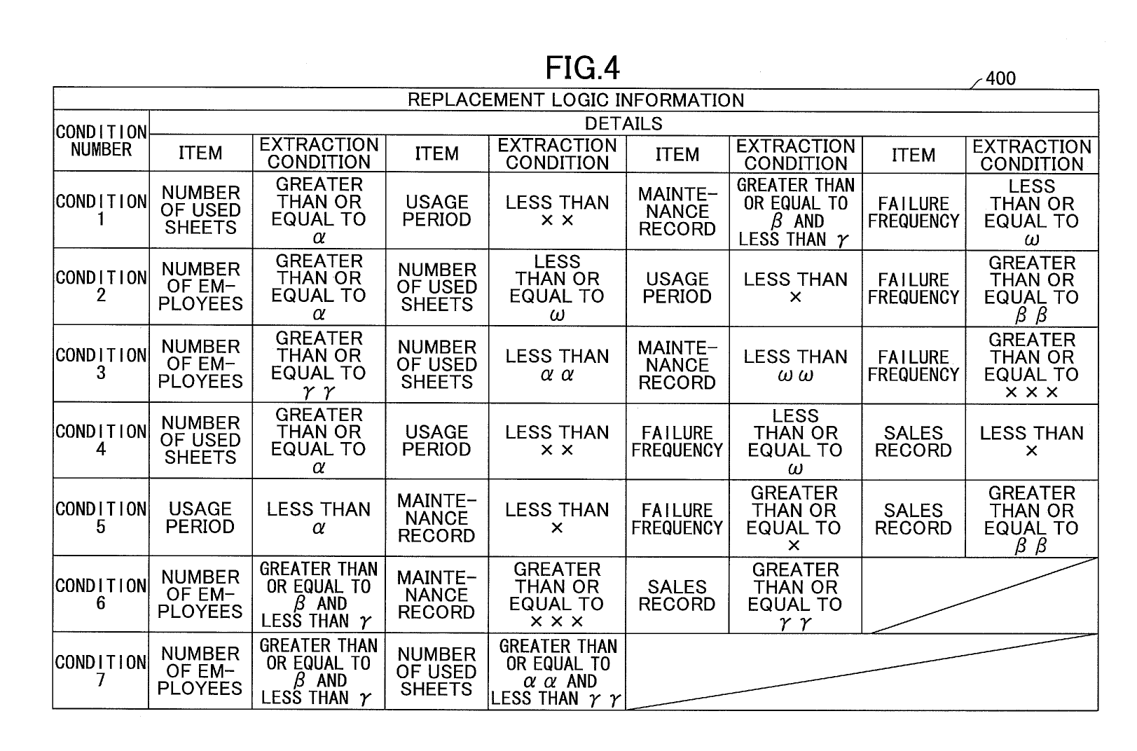

First, a description is given of replacement logic information 400 stored in the replacement logic information DB 153. FIG. 4 illustrates an example of the replacement logic information 400 stored in the replacement logic information DB 153.

As illustrated in FIG. 4, the replacement logic information 400 includes information items of “condition number” and “details”, and “details” include a plurality of combinations of “item” and “extraction condition”.

In the “condition number”, the number for identifying the condition of extracting an image forming apparatus that is highly likely to be replaced, is recorded. In the example of FIG. 4, as a condition of extracting an image forming apparatus that is highly likely to be replaced, seven types of conditions are defined, and therefore condition 1 through condition 7 are recorded in “condition number”.

In “item”, a parameter that is effective for extracting an image forming apparatus that is highly likely to be replaced is recorded, from among the collection information collected in the data collection server 140. In the present embodiment, a parameter that is effective for extracting an image forming apparatus that is highly likely to be replaced, is assumed to be determined by a human. In the example of FIG. 4, as such effective parameters, “number of used sheets” indicating the number of sheets used for copying, printing, etc., by the image forming apparatus, “usage period” indicating the time from when the image forming apparatus is delivered, and “maintenance record” indicating the number of times that the maintenance person has performed maintenance on the image forming apparatus, etc., are recorded. Furthermore, “failure frequency” indicating the number of times a failure has occurred in the image forming apparatus, “sales record” indicating the number of times the salesperson has visited the customer, and “number of employees” indicating the number of employees at the customer using the image forming apparatus, are recorded.

In “extraction condition”, with respect to the parameter included in each item, the threshold range that is the extraction condition for extracting an image forming apparatus that is highly likely to be replaced, is recorded.

As illustrated in FIG. 4, in each condition, a plurality of combinations of “item” and “extraction condition” are included, and when there is an image forming apparatus matching all combinations of “item” and “extraction condition”, such an image forming apparatus is determined to be an image forming apparatus that is highly likely to be replaced. For example, when an image forming apparatus corresponds to number of used sheets=greater than or equal to α, usage period=less than ××, maintenance record=greater than or equal to β and less than γ, and failure frequency=less than or equal to ω, this image forming apparatus matches condition 1, and is thus determined to be an image forming apparatus that is highly likely to be replaced, and is extracted as a priority sales target image forming apparatus.

Note that in the example of FIG. 4, seven types of conditions are given; however, the number of conditions for extracting an image forming apparatus that is highly likely to be replaced is not limited to the seven types illustrated in the example of FIG. 4. Furthermore, in the example of FIG. 4, six types of parameters are given as parameters defined in the items of the respective conditions (number of used sheets, usage period, maintenance record, failure frequency, number of employees, sales record); however, the number of parameters included in the replacement logic information is not limited to six types.

### <4.2 Model Selection Logic Information Stored in Model Selection Logic Information DB>

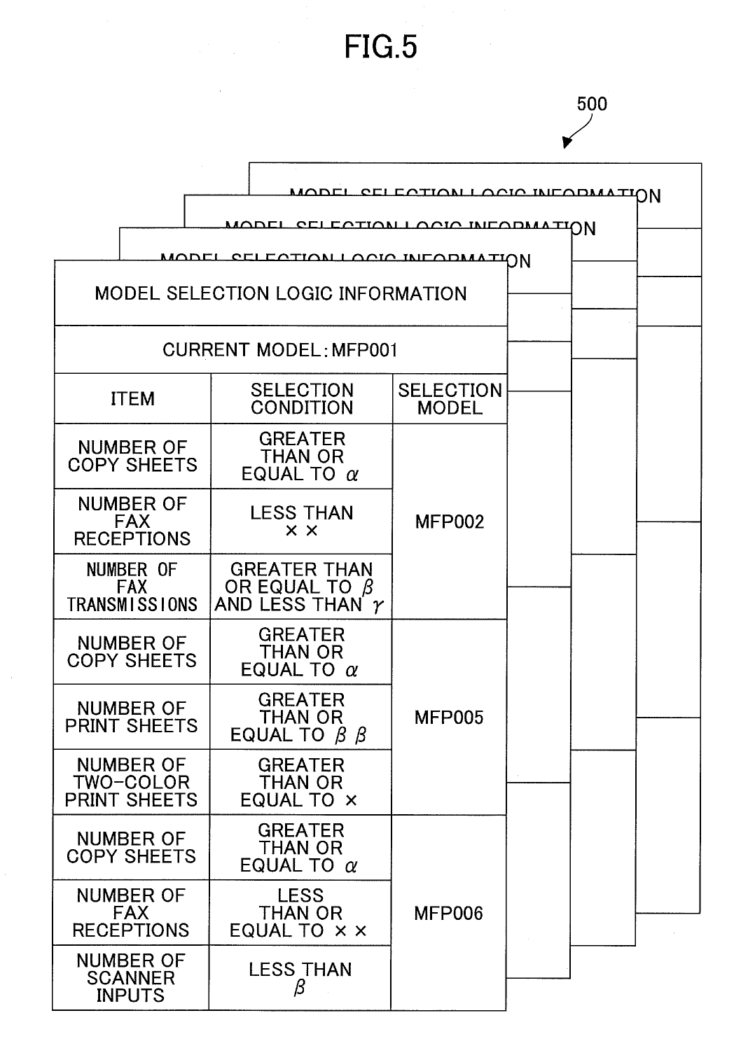

Next, a description is given of model selection logic information 500 stored in the model selection logic information DB 154. FIG. 5 illustrates an example of the model selection logic information 500 stored in the model selection logic information DB 154.

As illustrated in FIG. 5, the model selection logic information 500 is generated for each current model, and each set of model selection logic information 500 includes the information items of “item”, “selection condition”, and “selection model”.

In “item”, a parameter is recorded, which is effective for extracting a model that is highly likely to be selected by the customer as a replacement model. The parameter is selected from among the collection information collected in the data collection server 140. In the present embodiment, the parameter, which is effective for extracting a model that is highly likely to be selected by the customer as a replacement model, is assumed to be determined by a human. In the example of FIG. 5, as such effective parameters, “number of copy sheets” indicating the number of sheets used for copying by the image forming apparatus, “number of fax receptions” indicating the number of times a fax is received, and “number of fax transmissions” indicating the number of times a fax is sent, are recorded. Furthermore, “number of print sheets” indicating the number of sheets used for printing by the image forming apparatus, “number of two-color print sheets” indicating the number of sheets used for two-color printing, and “number of scanner inputs” indicating the number of times reading is performed by a scanner, are recorded.

In “selection condition”, with respect to the parameter included in each item, the threshold range for extracting a model that is highly likely to be selected by the customer as a replacement model, is recorded.

In “selection model”, a model, which is extracted when there is a model matching the plurality of combinations of “item” and “selection condition”, is recorded as a recommended model appropriate for replacement from the current model.

With respect to the same current model, different recommended models may be extracted, depending on the combination of “item” and “selection condition”. For example, for the same current model, different recommended models may be extracted for different image forming apparatuses, as follows. Specifically, when the usage record of one image forming apparatus is number of number of copy sheets=greater than or equal to α, number of fax receptions=less than ××, number of fax transmissions=greater than or equal to β and less than γ, MFP002 is extracted as the recommended model. Meanwhile, when the usage record of another image forming apparatus is number of number of copy sheets=greater than or equal to α, number of print sheets=greater than or equal to ββ, number of two-color print sheets=greater than or equal to ×, MFP005 is extracted as the recommended model. That is, a recommended model that suits the past usage record of the image forming apparatus by the customer, is extracted.

### <5. Functional Configuration of Data Analysis Server>

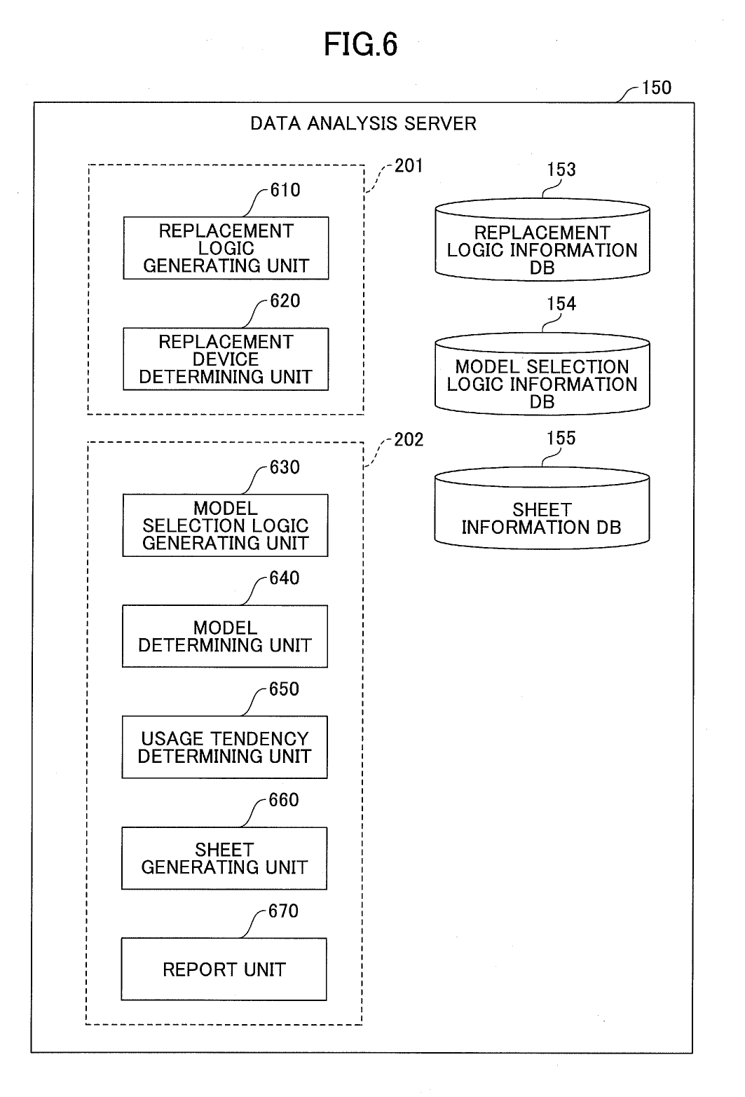

Next, a description is given of the replacement prediction function 201 and the sales support function 202, which are respectively implemented as the replacement prediction program 151 and the sales support program 152 installed in the data analysis server 150, are executed by the CPU 301. FIG. 6 illustrates an functional configuration of the data analysis server 150.

As illustrated in FIG. 6, the replacement prediction function 201 includes a replacement logic generating unit 610 and a replacement device determining unit 620. Furthermore, the sales support function 202 includes a model selection logic generating unit 630, a model determining unit 640, a usage tendency determining unit 650, a sheet generating unit 660, and a report unit 670.

The replacement logic generating unit 610 generates the replacement logic information 400. Specifically, the replacement logic generating unit 610 determines the combination of a parameter determined from among the collection information collected in the data collection server 140 and an extraction condition that is a threshold range of the determined parameter.

Note that the replacement logic generating unit 610 determines the combination of the parameter and the extraction condition, by using the collection information with respect to the image forming apparatus that has actually been replaced, among the image forming apparatuses of which information is collected in the data collection server 140.

Note that the replacement logic generating unit 610 stores the generated replacement logic information 400 in the replacement logic information DB 153.

The replacement device determining unit 620 reads the replacement logic information 400 from the replacement logic information DB 153. Furthermore, based on the read replacement logic information 400, the replacement device determining unit 620 determines an image forming apparatus that is highly likely to be replaced from among the sales target image forming apparatuses, and extracts the determined image forming apparatus as a priority sales target image forming apparatus.

Specifically, the replacement device determining unit 620 extracts collection information with respect to sales target image forming apparatuses from the data collection server 140, and determines whether the image forming apparatuses match the conditions (condition 1 through condition 7) in the replacement logic information 400. When an image forming apparatus is determined to match any one of the conditions in the replacement logic information 400, this sales target image forming apparatus is extracted as a priority sales target image forming apparatus.

The model selection logic generating unit 630 generates the model selection logic information 500. Specifically, the model selection logic generating unit 630 determines a combination of a parameter determined from among the collection information collected in the data collection server 140 and a selection condition that is a threshold range of the determined parameter.

Note that the model selection logic generating unit 630 determines the combination of the parameter and the selection condition, by using the collection information with respect to the image forming apparatus that has actually been replaced, among the image forming apparatuses of which information is collected in the data collection server 140.

The model selection logic generating unit 630 stores the generated model selection logic information 500 in the model selection logic information DB 154.

The model determining unit 640 reads the model selection logic information 500 from the model selection logic information DB 154. Furthermore, the model determining unit 640 extracts a recommended model with respect to the priority sales target image forming apparatus, based on the read model selection logic information 500.

Specifically, the model determining unit 640 acquires the collection information with respect to the priority sales target image forming apparatus, and determines whether there is a model that matches the conditions in the model selection logic information 500. When the model determining unit 640 determines that there is a model that matches any of the conditions in the model selection logic information 500, the model determining unit 640 extracts the model corresponding to the matching condition, as a recommended model.

The usage tendency determining unit 650 acquires the usage information included in the collection information with respect to the image forming apparatus extracted as the priority sales target image forming apparatus by the replacement prediction function 201, and analyzes the usage information as to whether there are any characteristics in the usage method by the customer. For example, the usage information includes the monthly usage record for the past 24 months, and the usage tendency determining unit 650 determines the characteristic in changes in time series. Furthermore, the usage tendency determining unit 650 reports the analyzed usage information and comments regarding the determined characteristic, as a usage tendency determination result, to the sheet generating unit 660.

The sheet generating unit 660 generates a sheet for each image forming apparatus extracted as a priority sales target image forming apparatus in the replacement device determining unit 620. Specifically, the sheet generating unit 660 arranges the recommended models extracted by the model determining unit 640, in the sheet. Furthermore, the sheet generating unit 660 arranges the usage information and the comments reported from the usage tendency determining unit 650, in the sheet. Furthermore, the sheet generating unit 660 acquires information for supporting the sales activities for replacement performed by the salesperson, from the collection information with respect to the priority sales target image forming apparatus, and arranges the acquired information in the sheet.

The report unit 670 sends an alert, addressed to the salesperson managing the image forming apparatus, when the priority sales target image forming apparatus is extracted by the replacement prediction function 201. Note that the report unit 670 attaches, to the alert, information for making it possible to acquire the sheet generated with respect to the priority sales target image forming apparatus.

### <6. Flow of Support Process in Support System>

Next, a description is given of a flow of a support process executed by the support system 100, by dividing the process into a logic construction phase and an alert execution phase.

### <6.1 Logic Construction Phase>

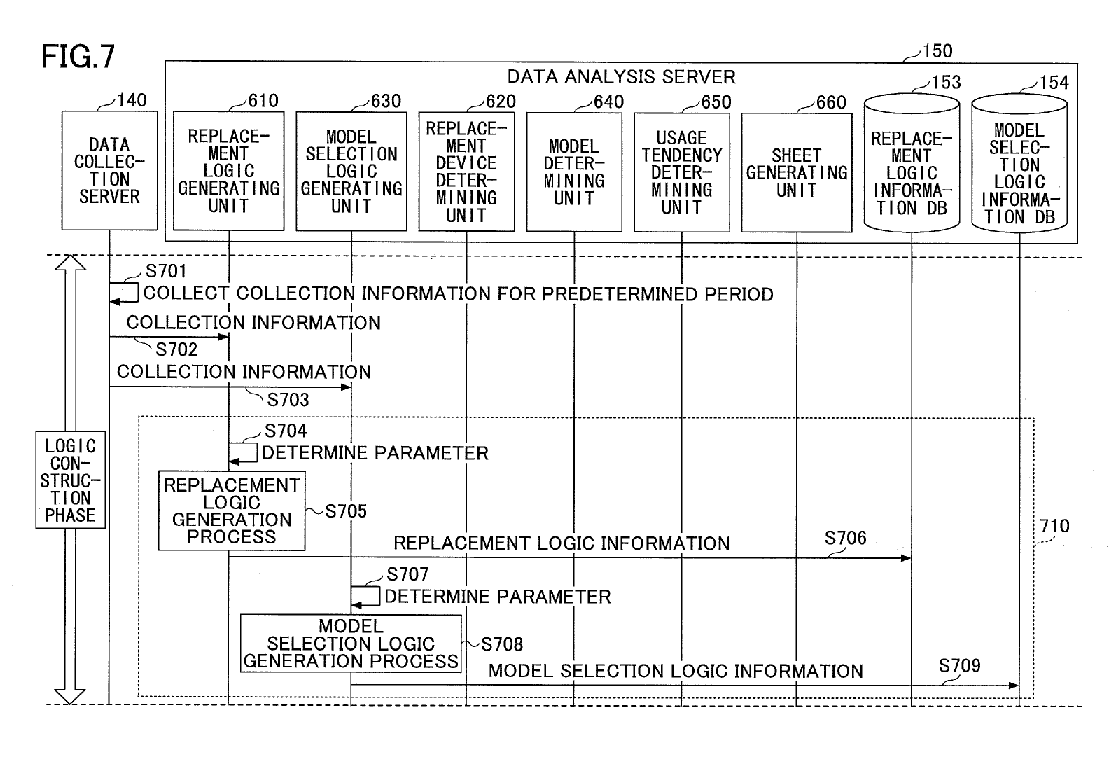

FIG. 7 is a sequence diagram illustrating a flow of a logic construction phase in the support process executed by the support system 100. As illustrated in FIG. 7, in step S701, the data collection server 140 collects collection information for a predetermined period. The data collection server 140 collects the collection information for, for example, a period of about three months. However, the collection period of collecting the collection information by the data collection server 140 is not limited to three months; for example, the period may be one year. An example of the collection information collected by the data collection server 140 is as described with reference to FIG. 2.

In steps S702 and S703, the data collection server 140 sends the collection information to the replacement logic generating unit 610 and the model selection logic generating unit 630 of the data analysis server 150.

In step S704, the replacement logic generating unit 610 determines a parameter that is effective for extracting an image forming apparatus that is highly likely to be replaced, from among the received collection information.

In step S705, the replacement logic generating unit 610 executes a replacement logic generation process of generating the replacement logic information 400 by determining combinations of the determined parameters and extraction conditions.

In step S706, the replacement logic generating unit 610 stores the generated replacement logic information 400 in the replacement logic information DB 153.

In step S707, the model selection logic generating unit 630 determines a parameter that is effective for extracting a model that is highly likely to be selected by the customer as a replacement model, from among the received collection information.

In step S708, the model selection logic generating unit 630 executes a model selection logic generation process of generating the model selection logic information 500 by determining combinations of the determined parameters and selection conditions.

In step S709, the model selection logic generating unit 630 stores the generated model selection logic information 500 in the model selection logic information DB 154.

Note that the logic construction phase of steps S701 through S709 may be performed only once in the support system 100, or may be periodically performed every time the data collection server 140 collects the collection information for a predetermined period.

Furthermore, the processes surrounded by the dotted line 710 in FIG. 7 (steps S704 through S709), may be executed by the owner of the data analysis server 150 in response to a request from the owner of the data collection server 140 or the owner of the information terminal 160. In this case, the owner of the data analysis server 150 may charge a fee to the owner who made the request. More specifically, for example, a fee may be charged according to the determination results of the plurality of combinations of parameters and threshold ranges.

### <6.2 Alert Execution Phase>

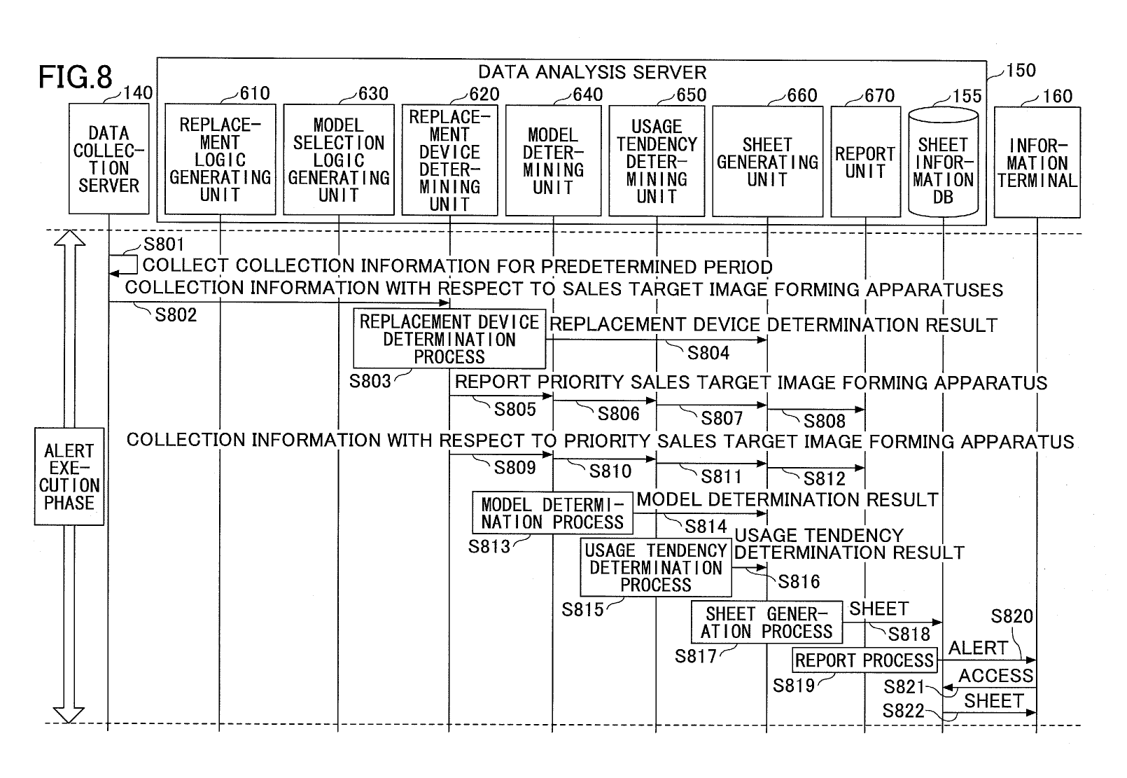

FIG. 8 is a sequence diagram illustrating a flow of an alert execution phase in the support process executed by the support system 100. As illustrated in FIG. 8, in step S801, the data collection server 140 collects collection information for a predetermined period. The collection period of data collection by the data collection server 140 is assumed to be, for example, about one month. An example of the collection information collected by the data collection server 140 is as described with reference to FIG. 2.

In step S802, the data collection server 140 sends collection information with respect to sales target image forming apparatuses, to the replacement device determining unit 620 of the data analysis server 150.

In step S803, the replacement device determining unit 620 executes a replacement device determination process based on the received collection information with respect to sales target image forming apparatuses, and extracts a priority sales target image forming apparatus. Furthermore, in step S804, the replacement device determining unit 620 reports the information relevant to conditions matching the replacement logic information 400 as a replacement device determination result to the sheet generating unit 660, when extracting the priority sales target image forming apparatus.

In step S805, the replacement device determining unit 620 reports the priority sales target image forming apparatus extracted in the replacement device determination process, to the model determining unit 640. Furthermore, in step S806, the priority sales target image forming apparatus is reported to the usage tendency determining unit 650. Furthermore, in steps S807 and S808, the priority sales target image forming apparatus is reported to the sheet generating unit 660 and the report unit 670, respectively.

In step S809, the replacement device determining unit 620 reports, to the model determining unit 640, the collection information with respect to priority sales target image forming apparatus, among the collection information with respect to the sales target image forming apparatuses received in step S802. Furthermore, in step S810, the collection information is reported to the usage tendency determining unit 650. Furthermore, in steps S811 and S812, the collection information is reported to the sheet generating unit 660 and the report unit 670, respectively.

In step S813, the model determining unit 640 performs a model determination process by using the collection information with respect to the priority sales target image forming apparatus, and extracts a recommended model. In step S814, the model determining unit 640 reports the model determination result to the sheet generating unit 660.

In step S815, the usage tendency determining unit 650 executes a usage tendency determination process. In step S816, the usage tendency determining unit 650 reports, to the sheet generating unit 660 as a usage tendency determination result, the usage information analyzed by executing the usage tendency determination process, and comments regarding the determined characteristic.

In step S817, the sheet generating unit 660 executes a sheet generation process of generating a sheet by using the collection information with respect to the priority sales target image forming apparatus reported in step S811. In executing the sheet generation process, the sheet generating unit 660 uses the replacement device determination result, the priority sales target image forming apparatus, the device determination result, and the usage tendency determination result, which have been reported in steps S804, S807, S814, and S816, respectively.

In step S818, the sheet generating unit 660 stores the generated sheet information in the sheet information DB 155. When the sheet is stored in the sheet information DB 155 by the sheet generating unit 660, the process proceeds to step S819.

In step S819, the report unit 670 performs a report process. As the report unit 670 performs the report process, in step S820, an alert is sent from the report unit 670 to the information terminal 160.

In step S821, the information terminal 160 that has received the alert accesses the sheet information DB 155 based on information that makes it possible to acquire the sheet of the priority sales target image forming apparatus included in the alert.

In step S822, the information terminal 160 reads the sheet information from the sheet information DB 155 and outputs the sheet information.

### <7. Details of Support Process>

Next, a description is given of details of the procedures of the support process executed by the support system 100. Specifically, a description is given of the replacement logic generation process (step S705) and the model selection logic generation process (step S708) in the logic construction phase. Furthermore, a description is given of the replacement device determination process (step S803), the model determination process (step S813), the usage tendency determination process (step S815), the sheet generation process (step S817), and the report process (step S819) in the alert execution phase.

### <7.1 Replacement Logic Generation Process>

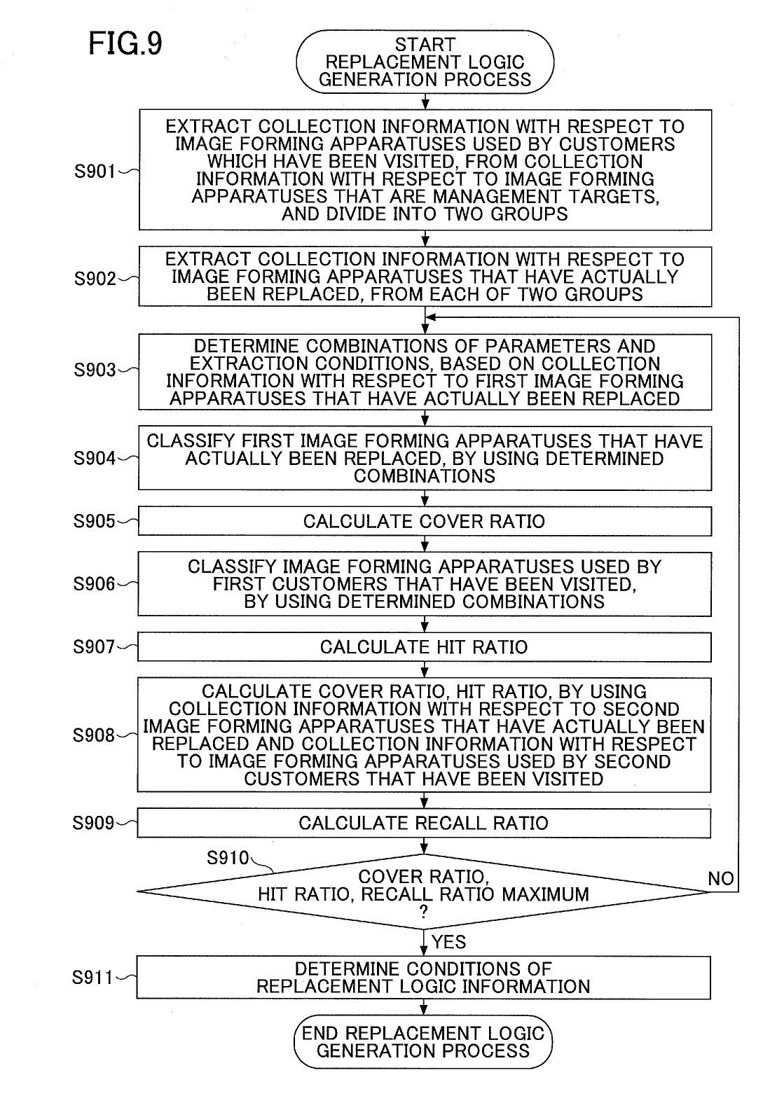

First, a description is given of details of the replacement logic generation process (step S705). FIG. 9 is a flowchart indicating a flow of the replacement logic generation process.

In step S901, the replacement logic generating unit 610 extracts collection information with respect to image forming apparatuses used by customers who have been visited by the salesperson, from among the collection information with respect to image forming apparatuses that are management targets sent from the data collection server 140. Furthermore, the replacement logic generating unit 610 divides the extracted collection information into two groups (here, as a matter of convenience, this is referred to as collection information with respect to image forming apparatuses used by first customers which have been visited, and collection information with respect to image forming apparatuses used by second customers which have been visited).

In step S902, the replacement logic generating unit 610 extracts collection information with respect to image forming apparatuses that have actually been replaced, from among the collection information extracted in step S901. Here, as a matter of convenience, collection information, which is extracted from the collection information with respect to image forming apparatuses used by first customers who have been visited, is referred to as collection information with respect to first image forming apparatuses that have actually been replaced. Furthermore, collection information, which is extracted from the collection information with respect to image forming apparatuses used by second customers who have been visited, is referred to as collection information with respect to second image forming apparatuses that have actually been replaced.

In step S903, the replacement logic generating unit 610 determines combinations of parameters and extraction conditions, based on collection information with respect to the first image forming apparatuses that have actually been replaced, extracted in step S902.

In step S904, the replacement logic generating unit 610 determines whether the collection information with respect to first image forming apparatuses that have actually been replaced, matches the combinations of parameters and extraction conditions determined in step S903. Accordingly, the first image forming apparatuses that have actually been replaced, are classified.

In step S905, the replacement logic generating unit 610 calculates a cover ratio, based on the classification result in step S904. Note that the cover ratio is the ratio of the number of image forming apparatuses matching the determined combinations of parameters and extraction conditions, with respect to the number of the first image forming apparatuses that have actually been replaced.

In step S906, the replacement logic generating unit 610 determines whether the collection information with respect to image forming apparatuses used by first customers who have been visited, matches the determined combinations of parameters and extraction conditions. Accordingly, the image forming apparatuses used by first customers who have been visited, are classified.

In step S907, the replacement logic generating unit 610 calculates a hit ratio, based on the classification result of step S906. A hit ratio is the ratio of the number of first image forming apparatuses that have actually been replaced, included in the image forming apparatuses matching the determined combinations of parameters and extraction conditions.

In step S908, the replacement logic generating unit 610 classifies the second image forming apparatuses that have actually been replaced by using the determined combinations of parameters and extraction conditions, and calculates a cover ratio. Furthermore, the replacement logic generating unit 610 classifies the image forming apparatuses used by second customers who have been visited by using the determined combinations of parameters and extraction conditions, and calculates a hit ratio.

In step S909, the replacement logic generating unit 610 calculates the difference between the cover ratio calculated in step S905 and the hit ratio calculated in step S907, and the cover ratio and the hit ratio calculated in step S908. Accordingly, a recall ratio is calculated. Note that the recall ratio indicates the extent of variation when cover ratios and hit ratios are calculated by using different sets of collection information. The smaller the variation, the higher the recall ratio, and the larger the variation, the lower the recall ratio.

In step S910, the replacement logic generating unit 610 determines whether the calculated cover ratio, hit ratio, and recall ratio are maximum (determination is made by setting the cover ratio, hit ratio, and recall ratio as evaluation indexes). When the determination of step S910 is not maximum, the process returns to step S903, different combinations of parameters and extraction conditions are determined, and the processes of step S904 through 5909 are performed.

Meanwhile, when the determination of step S910 is maximum, the process proceeds to step S911, the corresponding combinations of parameters and extraction conditions are determined to be the replacement logic information 400, to generate the replacement logic information 400.

### <7.2 Model Selection Logic Generation Process>

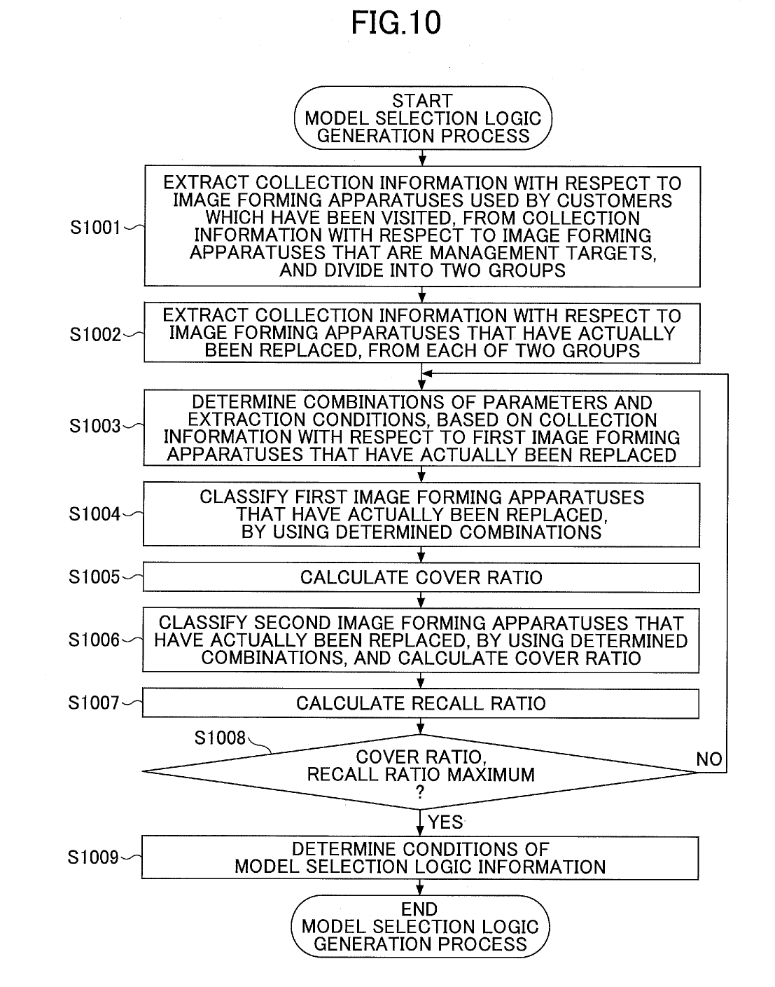

Next, a description is given of details of the model selection logic generation process (step S708). FIG. 10 is a flowchart indicating a flow of the model selection logic generation process.

In step S1001, the model selection logic generating unit 630 extracts collection information with respect to image forming apparatuses used by customers who have been visited by the salesperson, from among collection information with respect to image forming apparatuses that are management targets sent from the data collection server 140. Furthermore, the model selection logic generating unit 630 divides the extracted collection information into two groups (here, as a matter of convenience, there are referred to as collection information with respect to image forming apparatuses used by first customers which have been visited, and collection information with respect to image forming apparatuses used by second customers which have been visited).

In step S1002, the model selection logic generating unit 630 extracts collection information with respect to image forming apparatuses that have actually been replaced, from among the collection information with respect to the image forming apparatuses extracted in step S1001. Here, as a matter of convenience, collection information, which is extracted from the collection information with respect to image forming apparatuses used by first customers who have been visited, is referred to as collection information with respect to first image forming apparatuses that have actually been replaced. Furthermore, collection information, which is extracted from the collection information with respect to image forming apparatuses used by second customers who have been visited, is referred to as collection information with respect to second image forming apparatuses that have actually been replaced.

In step S1003, the model selection logic generating unit 630 determines combinations of parameters and extraction conditions, based on collection information with respect to the first image forming apparatuses that have actually been replaced, extracted in step S1002.

In step S1004, the model selection logic generating unit 630 determines whether the collection information with respect to first image forming apparatuses that have actually been replaced, matches the combinations of parameters and extraction conditions determined in step S1003. Accordingly, recommended models are extracted, with respect to the first image forming apparatuses that have actually been replaced.

In step S1005, the model selection logic generating unit 630 calculates a cover ratio, based on the recommended models extracted in step S1004. Note that the cover ratio is the ratio of the number of recommended models that match the actual replacement model, among the recommended models extracted in step S1004.

In step S1006, the model selection logic generating unit 630 determines whether the collection information with respect to second image forming apparatuses that have actually been replaced, matches the determined combinations of parameters and extraction conditions. Accordingly, recommended models are extracted, with respect to the second image forming apparatuses that have actually been replaced, and the cover ratio is calculated.

In step S1007, the model selection logic generating unit 630 calculates the difference between the cover ratio calculated in step S1005, and the cover ratio calculated in step S1006. Accordingly, a recall ratio is calculated. Note that the recall ratio indicates the extent of variation when cover ratios are calculated by using different sets of collection information. The smaller the variation, the higher the recall ratio, and the larger the variation, the lower the recall ratio.

In step S1008, the model selection logic generating unit 630 determines whether the calculated cover ratio and recall ratio are maximum (determination is made by setting the cover ratio and recall ratio as evaluation indexes). When the determination of step S1008 is not maximum, the process returns to step S1003, different combinations of parameters and extraction conditions are determined, and the processes of step S1004 through S1007 are performed.

Meanwhile, when the determination of step S1008 is maximum, the process proceeds to step S1009, the corresponding combinations of parameters and extraction conditions are determined to be the model selection logic information 500, and to generate the model selection logic information 500.

### <7.3 Replacement Device Determination Process>

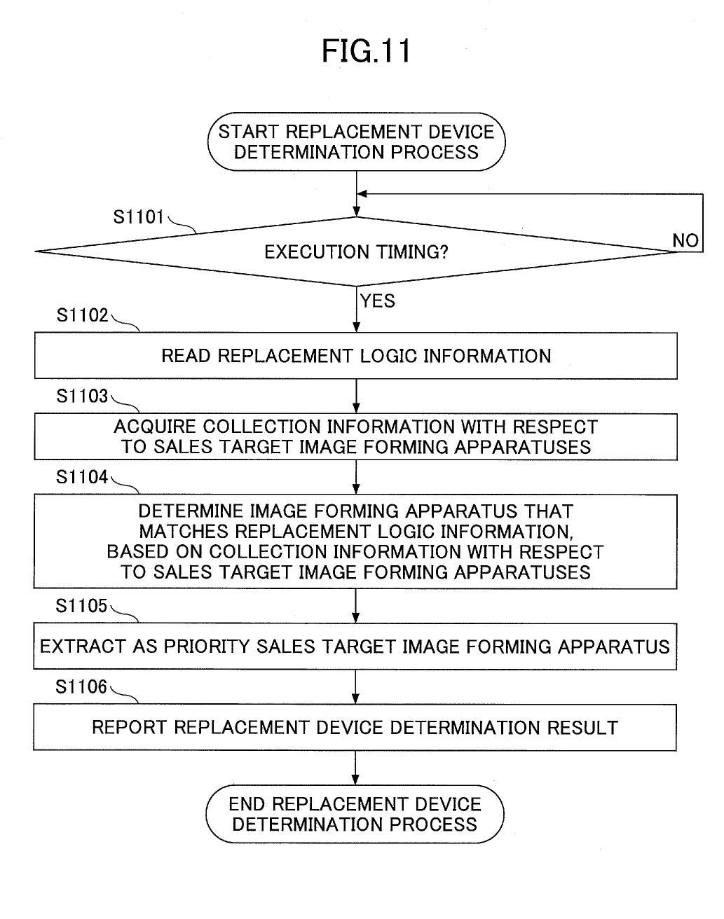

Next, a description is given of details of the replacement device determination process (step S803). FIG. 11 is a flowchart indicating a flow of the replacement device determination process.

In step S1101, the replacement device determining unit 620 determines whether the timing of executing the replacement device determination process has approached. For example, when one month has passed from the time of executing the previous replacement device determination process, the replacement device determining unit 620 determines that the execution timing has approached.

In step S1102, the replacement device determining unit 620 reads the replacement logic information 400 from the replacement logic information DB 153.

In step S1103, the replacement device determining unit 620 acquires collection information with respect to sales target image forming apparatuses, sent from the data collection server 140.

In step S1104, the replacement device determining unit 620 determines whether the collection information with respect to sales target image forming apparatuses extracted in step S1103 matches the conditions in the replacement logic information 400.

In step S1105, the replacement device determining unit 620 extracts, as a priority sales target image forming apparatus, the image forming apparatuses determined to match any of the conditions in the replacement logic information 400, as a result of the determination of step S1104.

In step S1106, the replacement device determining unit 620 reports the information relevant to the condition matching the replacement logic information 400, to the sheet generating unit 660 as a replacement device determination result.

### <7.4 Model Determination Process>

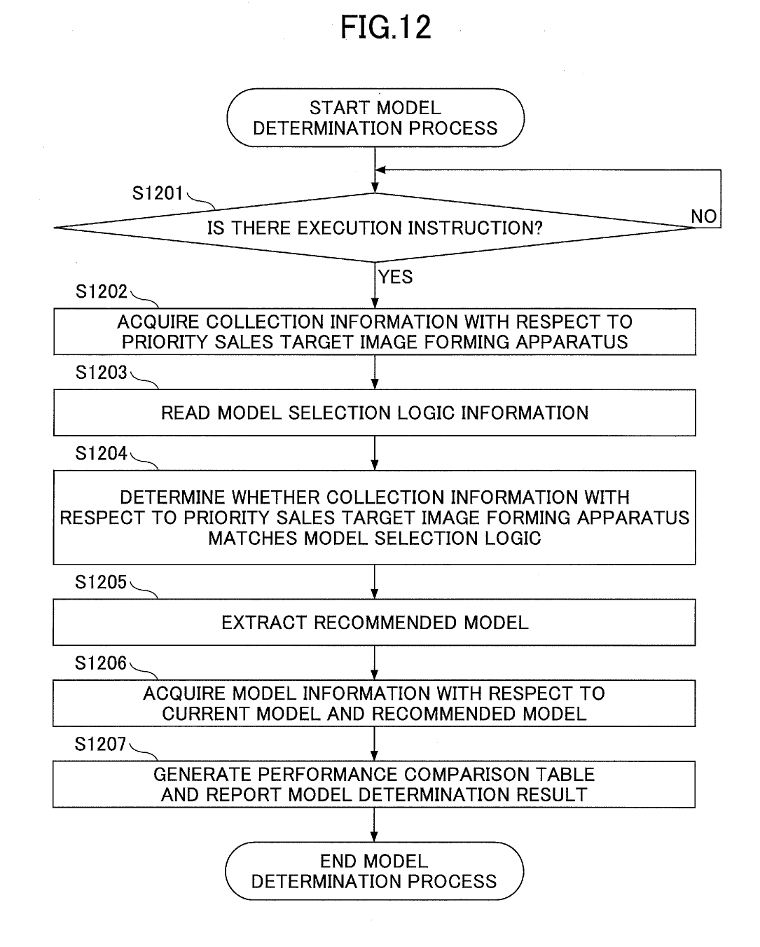

Next, a description is given of details of the model determination process (step S813). FIG. 12 is a flowchart indicating a flow of the model determination process.

In step S1201, the model determining unit 640 determines whether an instruction to execute a model determination process is given. The model determination process determines that an execution instruction is given, when a report of a priority sales target image forming apparatus is received from the replacement device determining unit 620.

In step S1202, the model determining unit 640 acquires the collection information with respect to the priority sales target image forming apparatus from the replacement device determining unit 620. In step S1203, the model determining unit 640 reads the model selection logic information 500 from the model selection logic information DB 154.

In step S1204, the model determining unit 640 determines whether the collection information with respect to the priority sales target image forming apparatus acquired in step S1202, matches the conditions in the model selection logic information 500.

In step S1205, the model determining unit 640 extracts a model corresponding to the condition determined to be matching in step S1204, as the recommended model.

In step S1206, the model determining unit 640 extracts model information with respect to the current model and model information with respect to the recommended model, from the collection information with respect to the priority sales target image forming apparatus. In step S1207, the model determining unit 640 generates a performance comparison table by using the model information with respect to the current model and model information with respect to the recommended model, and reports the generated performance comparison table together with the recommended model as a model determination result, to the sheet generating unit 660.

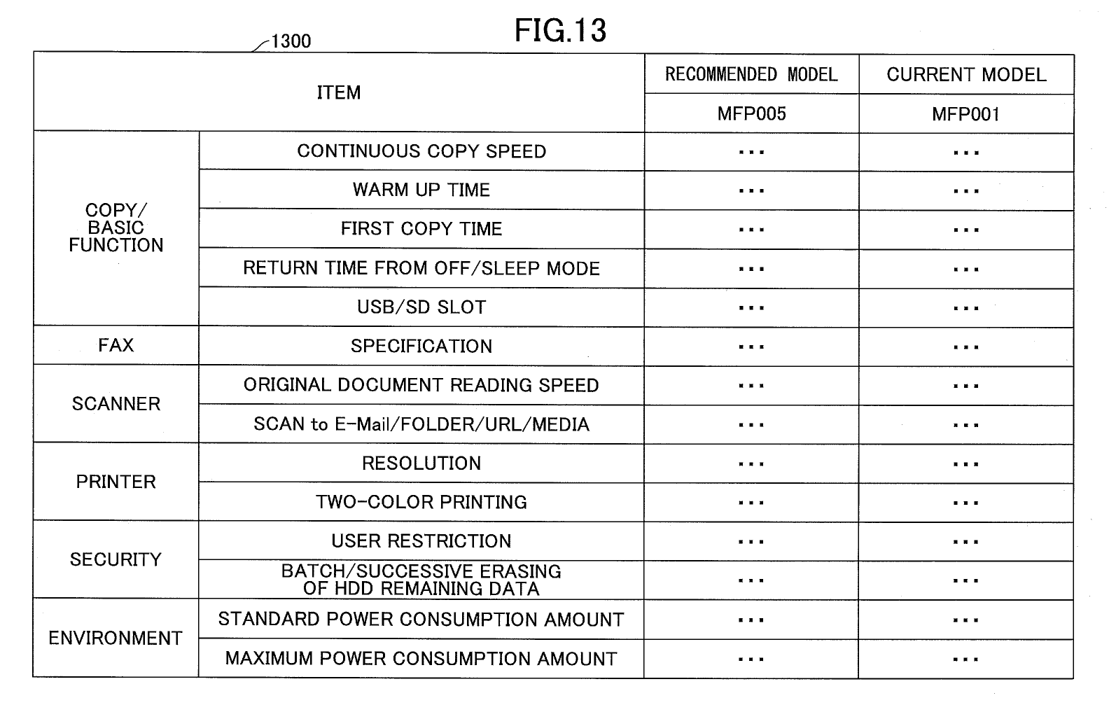

FIG. 13 illustrates an example of a performance comparison table 1300 generated by the model determining unit 640. As illustrated in FIG. 13, the performance comparison table 1300 includes information items of “copy/basic function”, “fax”, “scanner”, “printer,” “security”, and “environment”, and each of the information items further includes detailed information items.

The model determining unit 640 extracts, from the collection information with respect to the priority sales target image forming apparatus, the model information corresponding to the respective information items for the current model (in the example of FIG. 13, “MFP001”) and the recommended model (in the example of FIG. 13, “MFP005”), and records the extracted information. Accordingly, the performance comparison table 1300 is generated.

### <7.5 Usage Tendency Determination Process>

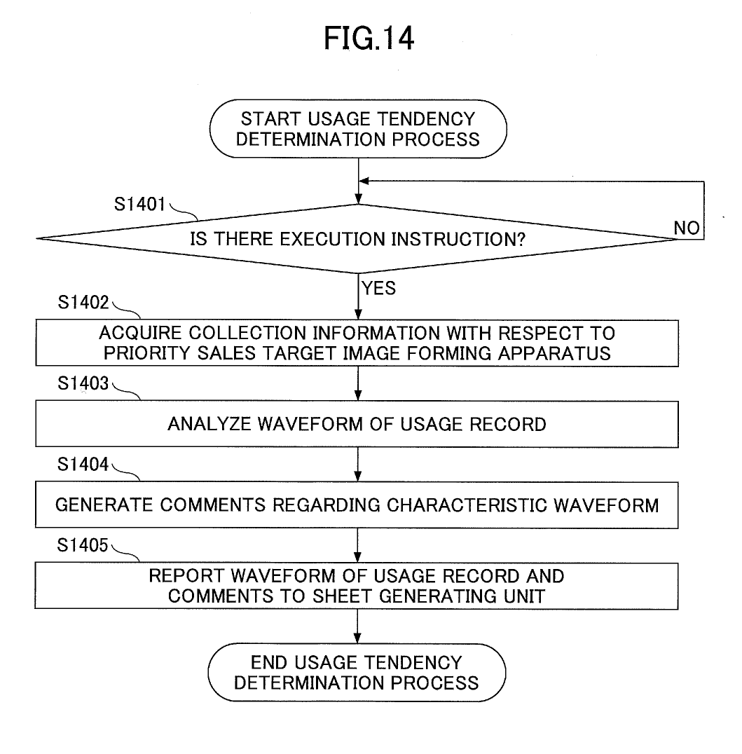

Next, a description is given of details of the usage tendency determination process (step S815). FIG. 14 is a flowchart indicating a flow of the usage tendency determination process.

In step S1401, the usage tendency determining unit 650 determines whether an instruction to execute a usage tendency determination process is given. The usage tendency determining unit 650 determines that an execution instruction is given, when a report of a priority sales target image forming apparatus is received from the replacement device determining unit 620.

In step S1402, the usage tendency determining unit 650 acquires the collection information with respect to the priority sales target image forming apparatus reported from the replacement device determining unit 620. In step S1403, the usage tendency determining unit 650 analyzes the waveforms of the usage record included in the acquired collection information. Note that the usage record included in the acquired collection information is assumed to be the monthly number of copy sheets, number of two-color copy sheets, number of print sheets, number of two-color print sheets, number of fax receptions, number of fax transmissions, and number of scanner inputs, in the past 24 months.

In step S1404, the usage tendency determining unit 650 generates comments regarding a characteristic waveform, based on the results of analyzing the waveforms of the usage record. In step S1405, the usage tendency determining unit 650 reports the waveform of the usage record and the comments as a usage tendency determination result, to the sheet generating unit 660.

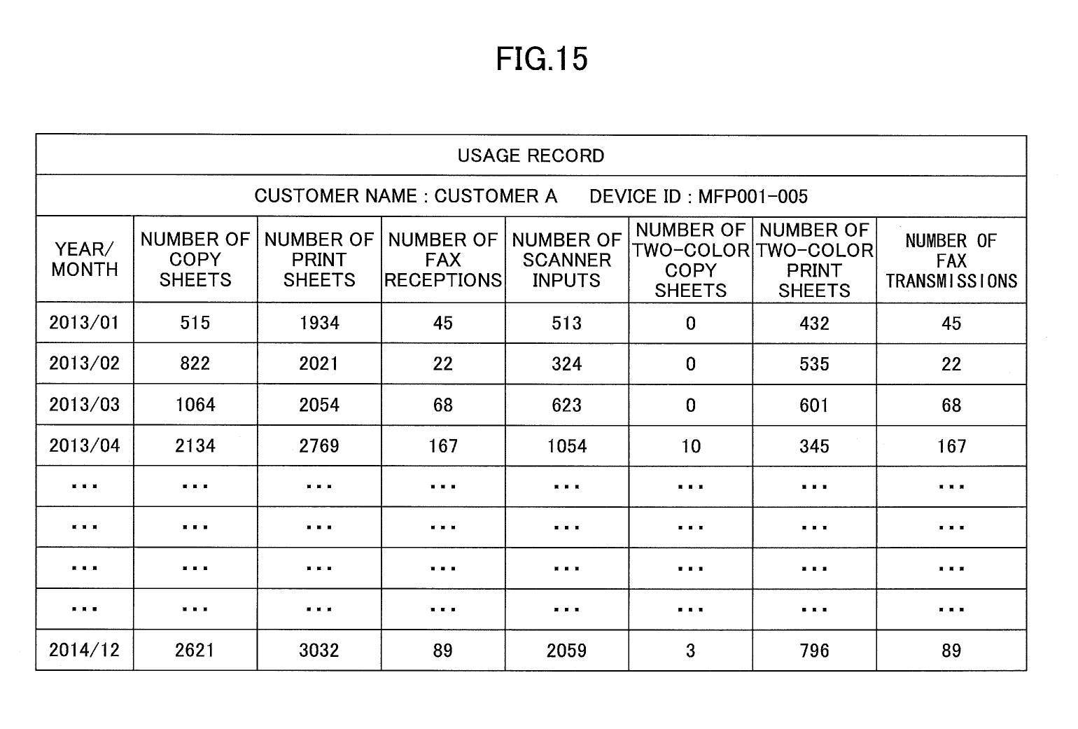

FIG. 15 illustrates an example of the usage record analyzed by the usage tendency determining unit 650. The example of FIG. 15 illustrates the usage record of image forming apparatuses having the device ID=MFP001-005 used by customer name=customer A.

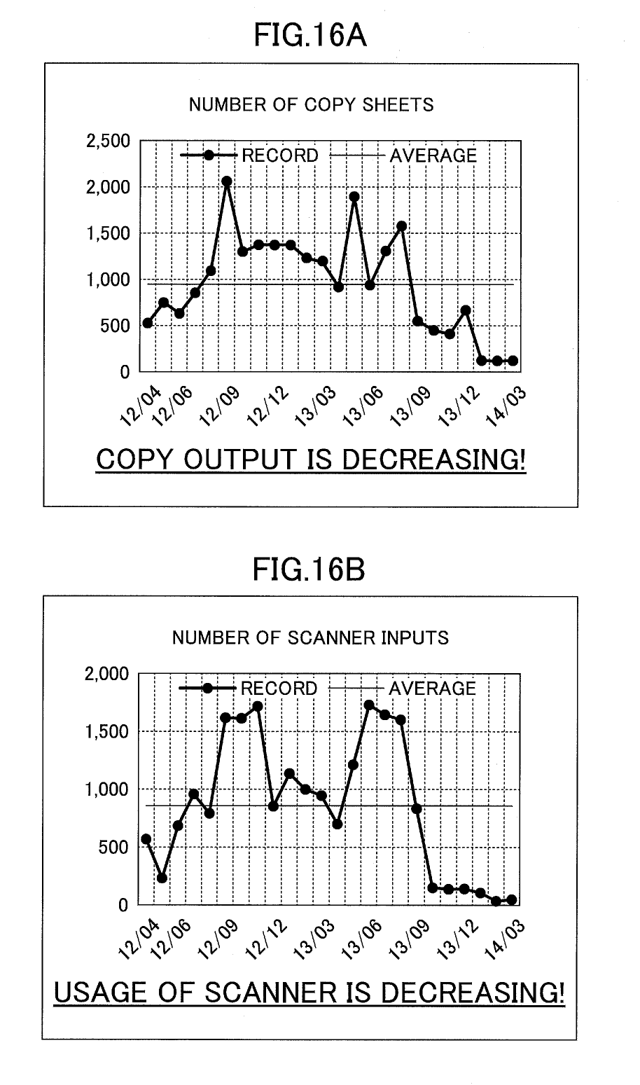

Furthermore, FIGS. 16A and 16B illustrate examples of graphs of waveforms in the past 24 months of the usage record with respect to the number of copy sheets and the number of scanner inputs, among the usage record indicated in FIG. 15, and comments. As illustrated in FIG. 16A, the waveform of the past 24 months with respect to the number of copy sheets indicates that the number of copy sheets in the past six months is decreasing, particularly the number of copy sheets in the past three months is decreasing. The usage tendency determining unit 650 detects such a characteristic waveform in the waveform of the usage record, and generates comments expressing the detected characteristic waveform. FIG. 16A indicates that the usage tendency determining unit 650 has generated a comment reading “copy output is decreasing!”.

Similarly, as illustrated in FIG. 16B, the waveform of the past 24 months with respect to the number of scanner inputs indicates that the number of scanner inputs in the past five months is decreasing. The usage tendency determining unit 650 detects such a characteristic waveform in the waveform of the usage record, and generates comments expressing the detected characteristic waveform. FIG. 16B indicates that the usage tendency determining unit 650 has generated a comment reading “usage of scanner is decreasing!”.

### <7.6 Sheet Generation Process>

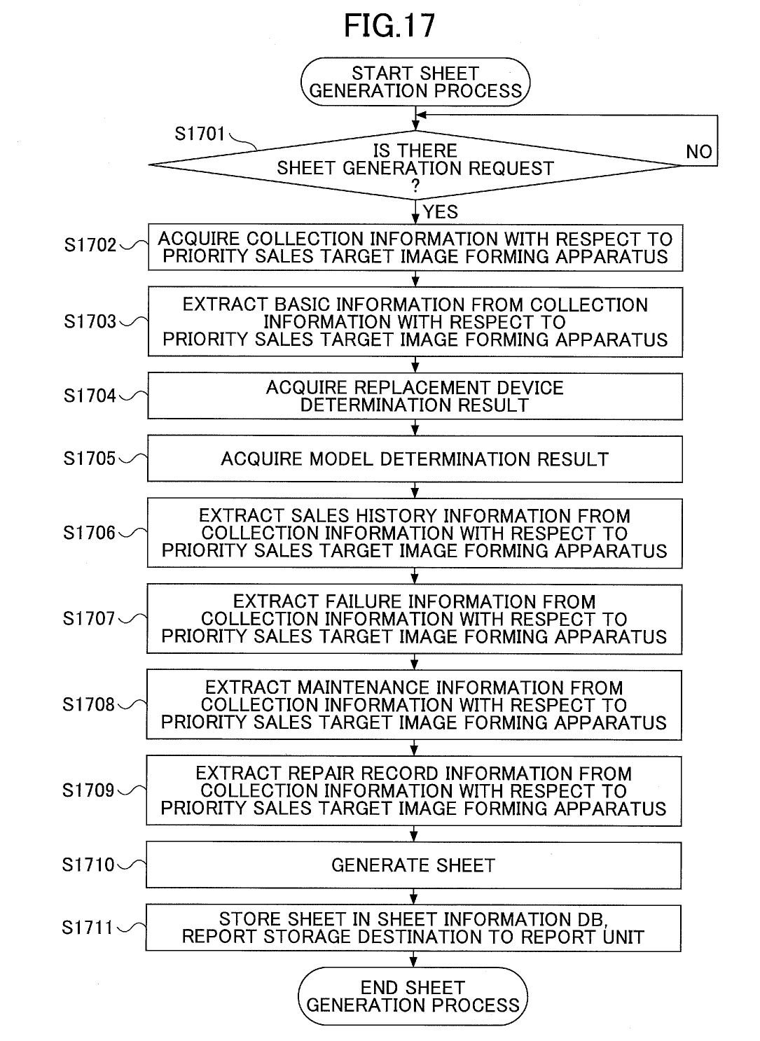

Next, a description is given of details of the sheet generation process (step S817). FIG. 17 is a flowchart indicating a flow of the sheet generation process.

In step S1701, the sheet generating unit 660 determines whether a sheet generation request has been received. The sheet generating unit 660 determines that a sheet generation request has been received, when a report of a priority sales target image forming apparatus is received from the replacement device determining unit 620.

In step S1702, the sheet generating unit 660 acquires collection information with respect to the priority sales target image forming apparatus reported from the replacement device determining unit 620. In step S1703, the sheet generating unit 660 extracts basic information from the collection information with respect to the identified priority sales target image forming apparatus. The basic information includes the customer name and the business office name of the customer using the image forming apparatus, the location of the business office, the delivery date of the image forming apparatus, the device ID of the image forming apparatus, the contract form, etc.

In step S1704, the sheet generating unit 660 acquires the replacement device determination result from the replacement device determining unit 620. In step S1705, the sheet generating unit 660 acquires the recommended model and the performance comparison table as the model determination result, from the model determining unit 640.

In step S1706, the sheet generating unit 660 extracts, from the collection information with respect to the priority sales target image forming apparatus, the sales history information of the salesperson with respect to the customer using the identified priority sales target image forming apparatus.

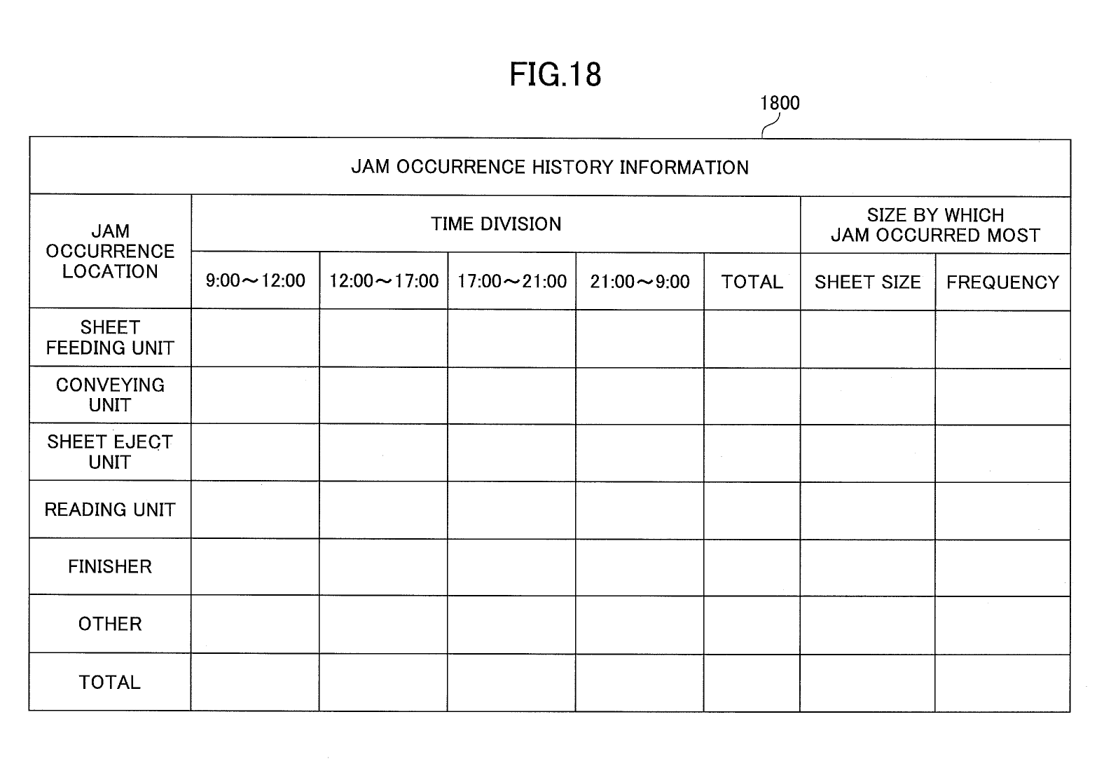

In step S1707, the sheet generating unit 660 extracts failure information from the collection information with respect to the identified priority sales target image forming apparatus. FIG. 18 illustrates an example of jam occurrence history information that is an example of failure information. As illustrated in FIG. 18, jam occurrence history information 1800 includes information items of “jam occurrence location”, “time division”, and “size by which jam occurred most”.

In the “jam occurrence location”, the names of the respective parts of the image forming apparatus are recorded. “Time division” further includes time periods into which the time is divided and “total”, and the number of times that paper jams have occurred in each time period is recorded for each of the jam occurrence locations.

The “size by which jam occurred most” further includes a “sheet size” and a “frequency”, and the sheet size by which paper jams occurred the most and the occurrence frequency are recorded for each of the jam occurrence locations.

Referring back to FIG. 17, in step S1708, the sheet generating unit 660 extracts maintenance information from the collection information with respect to the identified priority sales target image forming apparatus. The maintenance information includes the time and date on which the maintenance person has performed maintenance on the image forming apparatus and the frequency of performing maintenance; here, for the past 24 months, the monthly number of times that the maintenance person has performed maintenance on the image forming apparatus is extracted.

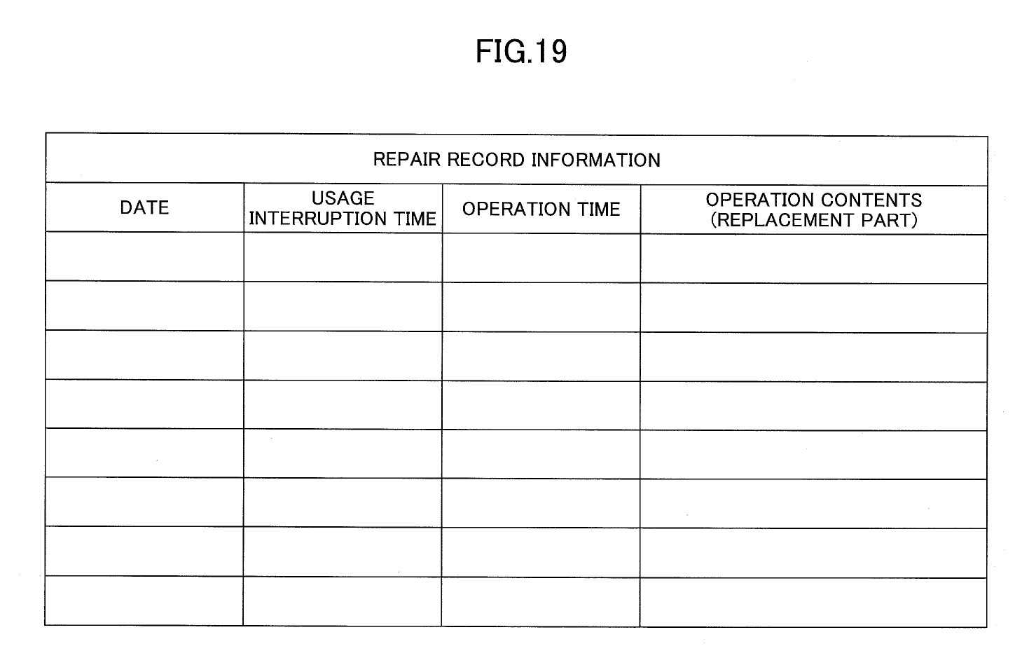

In step S1709, the sheet generating unit 660 extracts repair record information from the collection information with respect to the identified priority sales target image forming apparatus. FIG. 19 illustrates an example of repair record information. As illustrated in FIG. 19, the repair record information includes items of “date”, “usage interruption time”, “operation time”, and “operation contents (replacement part)”.

In the “date”, the date on which the maintenance person has performed the repair is recorded. In the “usage interruption time”, the time during which usage of the image forming apparatus has been interrupted due to a failure, is recorded. In “operation time”, the operation time when the maintenance person has actually performed the repair is recorded. In “operation contents”, information relevant to the part that has been replaced at the time of repair is recorded.

Referring back to FIG. 17, in step S1710, the sheet generating unit 660 generates a sheet with respect to the identified priority sales target image forming apparatus, based on the information acquired in steps S1703 through S1709.

In step S1711, the sheet generating unit 660 stores the generated sheet in the sheet information DB 155. Furthermore, the sheet generating unit 660 reports the storage destination to the report unit 670.

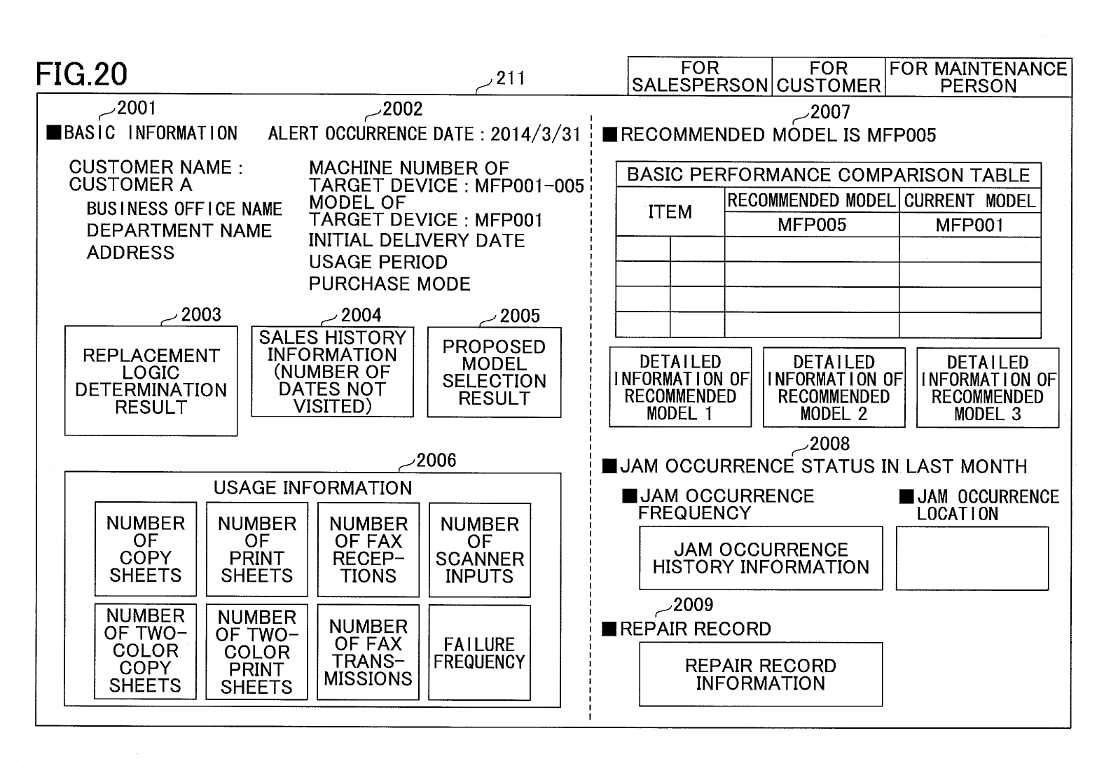

FIG. 20 illustrates an example of a sheet 211 generated by the sheet generating unit 660. As illustrated in FIG. 20, in the basic information description field 2001, basic information with respect to the customer using the image forming apparatus determined as the priority sales target image forming apparatus by the replacement device determination process, is described. The example of FIG. 20 indicates that the image forming apparatus having the device ID=MFP001-005 is determined to be the priority sales target image forming apparatus, and the customer using the image forming apparatus is customer A.

In the alert occurrence date description field 2002, the date on which the image forming apparatus having the device ID ID=MFP001-005 has been determined to be the priority sales target image forming apparatus by the replacement device determination process, is described.

In the replacement logic determination result description field 2003, the replacement device determination result reported from the replacement device determining unit 620 is described. As described above, the replacement device determination result includes information relevant to the condition matching the replacement logic information 400, when the priority sales target image forming apparatus is extracted by the replacement device determining unit 620.

For example, it is assumed that the image forming apparatus having the device ID=MFP001-005 is extracted as the priority sales target image forming apparatus by satisfying the “condition 1”. In this case, in the replacement logic determination result description field 2003, “number of used sheets”, “usage period”, “maintenance record”, and “failure frequency” are described, among the collection information with respect to the image forming apparatus having the device ID=MFP001-005.

Note that the plurality of combinations of parameters and extraction conditions in the respective conditions in the replacement logic information 400 are merely determined based on a mathematical process. Therefore, even if the collection information matching the extraction conditions of parameters defined in the replacement logic information 400 is directly described in the replacement logic determination result description field 2003, the salesperson may not necessarily be able to understand this information. Thus, the sheet generating unit 660 may describe simple comments in the replacement logic determination result description field 2003, instead of describing the collection information matching the extraction conditions of parameters defined in the replacement logic information 400.

In the sales history information description field 2004, the number of dates not visited is described, which is calculated based on the sales history information extracted from the collection information with respect to the priority sales target image forming apparatus in the sheet generation process. In the sales history information, the history of the previous access (activity information such as the date when the salesperson has previously visited customer A, the date when sales activities have previously been performed by telephone with respect to the customer A, etc.) is recorded, and therefore it is possible to calculate the number of dates not visited based on the history of the access.

In the proposed model selection result description field 2005, the recommended model included in the model determination result reported from the model determining unit 640 in the model determination process, is described.

In the usage information description field 2006, the usage tendency determination result with respect to the priority sales target image forming apparatus having the device ID=MFP001-005 (including comments generated in the usage tendency determination process) and failure information are described. The usage tendency determination results include the monthly number of copy sheets, number of print sheets, number of fax receptions, number of scanner inputs, number of two-color copy sheets, number of two-color print sheets, and number of fax transmissions for the past 24 months, and therefore the corresponding graphs are illustrated. Furthermore, in the usage tendency determination process, when a characteristic waveform is detected and comments are generated, the generated comments are also described. Furthermore, the failure information includes the monthly failure frequency for the past 24 months, and therefore the corresponding graph is illustrated.

In the recommended model description field 2007, the name of the recommended model reported from the model determining unit 640 in the model determination process, and the performance comparison table 1300, are described. Furthermore, detailed information relevant to the recommended model is described.

In the jam occurrence status description field 2008, the jam occurrence history information 1800 that has been acquired from the collection information in the sheet generation process, is described. Furthermore, a diagram indicating the jam occurrence location is illustrated.

In the repair record information description field 2009, the repair record information 1900 that has been acquired from the collection information in the sheet generation process, is described.

Note that there are three types of sheets generated by the sheet generating unit 660, i.e., a sheet for the salesperson, a sheet for the customer, and a sheet for the maintenance person. The sheet for the salesperson is a sheet used by the salesperson when performing sales activities, and the sheet for the customer is a sheet presented to the customer when performing sales activities. The sheet for the maintenance person is a sheet that the maintenance person brings to the customer when performing maintenance activities. This is because the maintenance person may perform supplementary sales activities.

The sheet 211 illustrated in FIG. 20 is an example of a sheet for a salesperson. In the case of the sheet for a customer, for example, the descriptions of the replacement logic determination result description field 2003 and the sales history information description field 2004 are omitted. Furthermore, in the case of a sheet for a maintenance person, for example, the contents described in the jam occurrence status description field 2008 and the repair record information description field 2009 are described in more detailed than the contents for the salesperson.

### <7.7 Report Process>

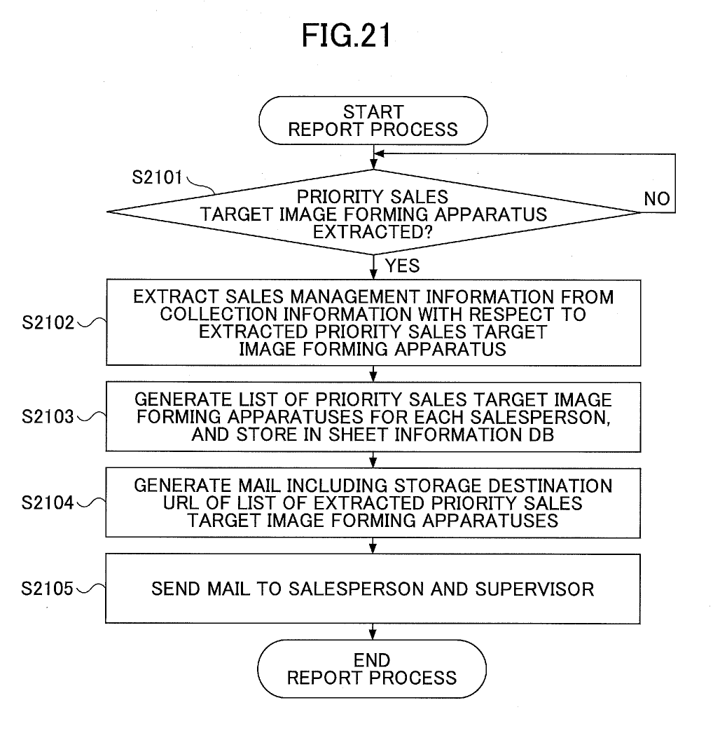

Next, a description is given of details of the report process (step S819). FIG. 21 is a flowchart indicating a flow of the report process.

In step S2101, the report unit 670 determines whether a priority sales target image forming apparatus has been extracted by the replacement device determining unit 620. When it is determined that a priority sales target image forming apparatus has not been extracted in step S2101, it is waited until a priority sales target image forming apparatus is extracted. Meanwhile, when it is determined that a priority sales target image forming apparatus has been extracted in step S2101, the process proceeds to step S2102.

In step S2102, the report unit 670 acquires the collection information with respect to the extracted priority sales target image forming apparatus, from the replacement device determining unit 620. In step S2103f, the report unit 670 extracts sales management information from the acquired collection information with respect to the priority sales target image forming apparatus. Accordingly, it is possible to identify the salesperson managing the priority sales target image forming apparatus. In the sales management information, the correspondence relationship between the salesperson, the image forming apparatuses that are management targets managed by the salesperson, and the customers using these image forming apparatuses, is recorded. Accordingly, the report unit 670 can identify the salesperson managing the priority sales target image forming apparatus, by reading the salesperson associated with the priority sales target image forming apparatus, from the sales management information.

In step S2103, the report unit 670 generates a file (data) including the list of priority sales target image forming apparatuses of the respective salespersons, and stores the file in the sheet information DB 155. Note that it is assumed that the storage destinations of the sheets (for salesperson, for customer, and for maintenance persons) generated by the sheet generating unit 660 are associated to each of the priority sales target image forming apparatuses included in the list of priority sales target image forming apparatuses.

In step S2104, the report unit 670 generates a mail including the URL of the storage destination in which the file of the list of priority sales target image forming apparatuses is stored. In step S2105, the report unit 670 sends the generated mail (alert), addressed to the corresponding salesperson and the supervisor (for example, the superior of the salesperson). Note that the mail is sent not only to the salesperson but also to the supervisor, because it is usually often the supervisor of the salesperson that determines the sales destination of the salesperson.

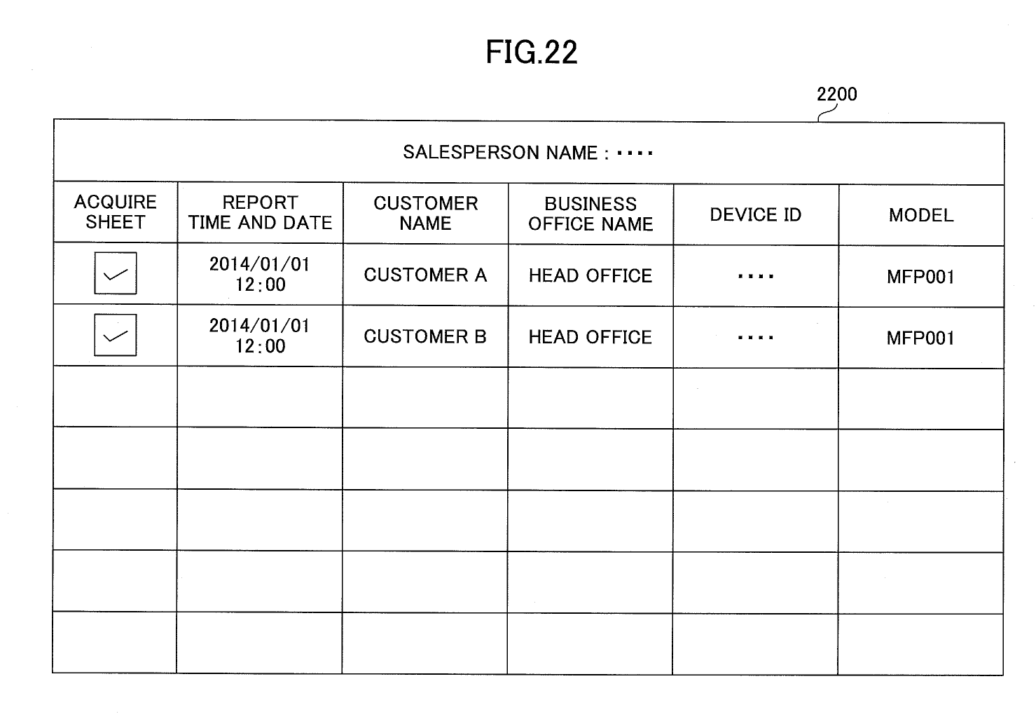

FIG. 22 illustrates an example of a list of priority sales target image forming apparatuses generated by the report unit 670. As illustrated in FIG. 22, the list of priority sales target image forming apparatuses 2200 is generated for each salesperson, and includes information items of “acquire sheet”, “report time and date”, “customer name”, “business office name”, “device ID”, and “model”.

In “acquire sheet”, tick boxes are provided, and when the salesperson inputs a tick in the tick box, a sheet with respect to the corresponding priority sales target image forming apparatus can be read from the sheet information DB 155 and can be output. In “report time and date”, the time and date when the report unit 670 first reported the corresponding image forming apparatus as the priority sales target image forming apparatus to the salesperson, is described.

In “customer name”, the name of the customer using the priority sales target image forming apparatus is described. In “business office name”, the business office name where the priority sales target image forming apparatus is installed, is described. In “device ID”, the device ID for identifying the priority sales target image forming apparatus, is described. In “model”, the model of the priority sales target image forming apparatus, is recorded.

In the case of the list of priority sales target image forming apparatuses 2200 illustrated in FIG. 22, it is indicated that two priority sales target image forming apparatuses are included in the image forming apparatuses that are management targets of the salesperson. Accordingly, the salesperson is able to prioritize sales activities of visiting customer A and customer B who are using these two priority sales target image forming apparatuses.

### <8. Overview>

As it is clear from the above descriptions, the support system 100 according to the present embodiment has the following configuration.
By analyzing the collection information stored in the data collection server, replacement logic information, which defines conditions for extracting an image forming apparatus that is highly likely to be replaced, is generated.
Based on the generated replacement logic information, a priority sales target image forming apparatus for which sales activities are to be prioritized, is extracted from the sales target image forming apparatuses.
For each priority sales target image forming apparatus, a sheet for supporting sales activities by the salesperson, is generated.
When a priority sales target image forming apparatus is extracted, this is reported to the salesperson, and the salesperson can access the sheet generated with respect to the corresponding image forming apparatus.

Accordingly, the salesperson is able to recognize the priority sales target image forming apparatus for which sales activities are to be prioritized, from among the sales target image forming apparatuses, and is able to visit the customer at a timing appropriate for replacement. Furthermore, the salesperson is able to give explanations appropriate for replacing the priority sales target image forming apparatus, to the customer. That is, by the support system 100, it is possible to support sales activities by the administrator, in replacing the image forming apparatus managed by the administrator.

### Second Embodiment

In the above first embodiment, an image forming apparatus is described as the management target; however, the management target is not limited to an image forming apparatus. As long as the target is managed by the administrator after being delivered to the customer, other targets are applicable. Thus, in the present embodiment, a description is given of a case where the support system 100 is applied when the management target is a vehicle. Note that the points that are different from the first embodiment are mainly described.

### <1. Overview of Functions Implemented in Support System>

First, a description is given of an overview of functions implemented in the support system 100. In the support system 100 according to the present embodiment, vehicles that are highly likely to be replaced by customer A, customer B, customer C, and so on, are extracted from the vehicles managed by the salesperson. Furthermore, when a vehicle that is highly likely to be replaced is extracted, this is reported to the salesperson. Also, when the salesperson performs sales activities for the customer using the extracted vehicle, a sheet by which the salesperson can make a proposal according to the customer's needs is generated, and the sheet is provided to the salesperson.

By these functions (hereinafter, replacement prediction function 2301 and sales support function 2302) provided in the support system 100, the salesperson can visit the customer at a timing appropriate for replacement, and make a proposal according to the customer's needs.

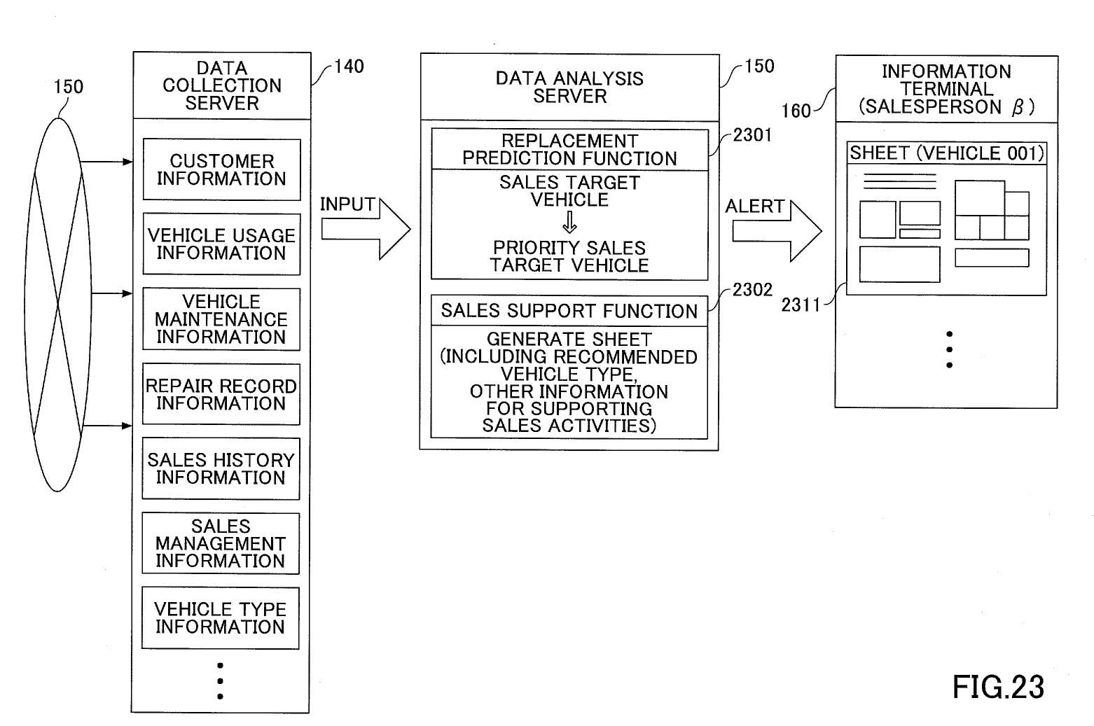

FIG. 23 illustrates an overview of functions provided in the support system 100. As illustrated in FIG. 23, for implementing the replacement prediction function and the sales support function, the data collection server 140 collects collection information. The collection information collected by the data collection server 140 includes, for example, customer information, vehicle usage information, vehicle maintenance information, repair record information, sales history information, sales management information, vehicle type information, etc.

The customer information includes any kind of information relevant to the customer, ranging from general information such as information for identifying the vehicle owned by the customer (vehicle type, model year, etc.), and the name, age, gender, address, etc., of the customer, to the driving record, the family structure, the ages and genders of family members, etc.

The vehicle usage information includes, for example, the monthly travel distance, average fuel efficiency, highway usage fee, fueling frequency, average accelerator position, tire air pressure, average speed when travelling, failure frequency, etc., of the vehicle, in the past 24 months. Furthermore, the vehicle usage information includes information about the destination set in the navigation system, and information about whether a general road or a highway has been used to go to the destination.

The vehicle maintenance information includes the date and the contents of the periodic inspection of the vehicle. The sales history information includes the number of times the salesperson has visited the customer, the number of times the salesperson has sent direct mails, the number of times a customer has visited the store, etc.

The repair record information includes any information relevant to the repair record such as the failure history, the repair contents and the number of days taken for the repair when a mechanic has repaired a failed vehicle, information relevant to the replaced parts, etc.

The sales management information includes information indicating the correspondence relationship between the salesperson, the area managed by the salesperson, and the customers belonging to the area.

The vehicle type information includes information relevant to the performance of all vehicle types handled by the salesperson.

Note that the collection information illustrated in FIG. 23 is merely one example of information collected by the data collection server 140; information other than the collection information illustrated in FIG. 23 may be collected. However, the information collected by the data collection server 140 preferably includes information indicating the importance degree of the vehicle for the customer and information relevant to brand loyalty.

In the data analysis server 150, the collection information collected by the data collection server 140 is used to realize the replacement prediction function 2301 and the sales support function 2302. In the data analysis server 150, parameters that are effective for realizing the replacement prediction function 2301 and the sales support function 2302 are extracted from the huge amount of collection information collected by the data collection server 140. Then, based on an optimum combination of the parameters, the replacement prediction function 2301 and the sales support function 2302 are realized.

The replacement prediction function 2301 extracts a vehicle that is a sales target, from among the vehicles that are management targets managed by the salesperson. Furthermore, the replacement prediction function 2301 extracts a vehicle that is a priority sales target, from among the sales target vehicles.

The sales support function 2302 creates a sheet for supporting sales activities by the salesperson, for each of the extracted priority sales target vehicles. The sheet includes the recommended vehicle type when replacing the priority sales target vehicle, record information unique to the corresponding vehicle (vehicle usage information, vehicle maintenance information, destination list information, repair record information, etc.), etc.

Furthermore, when the priority sales target vehicle is extracted, the sales support function 2302 sends a report indicating that the priority sales target vehicle has been extracted (sending an alert), addressed to the salesperson managing the corresponding image forming apparatus. By receiving an alert, the salesperson (salesperson β in the example of FIG. 23) recognizes the customer for which sales activities are to be prioritized. Furthermore, by accessing the data analysis server 150 via the information terminal 160, the salesperson β can acquire and output a sheet 2311.

### <2. Example of Sheet>

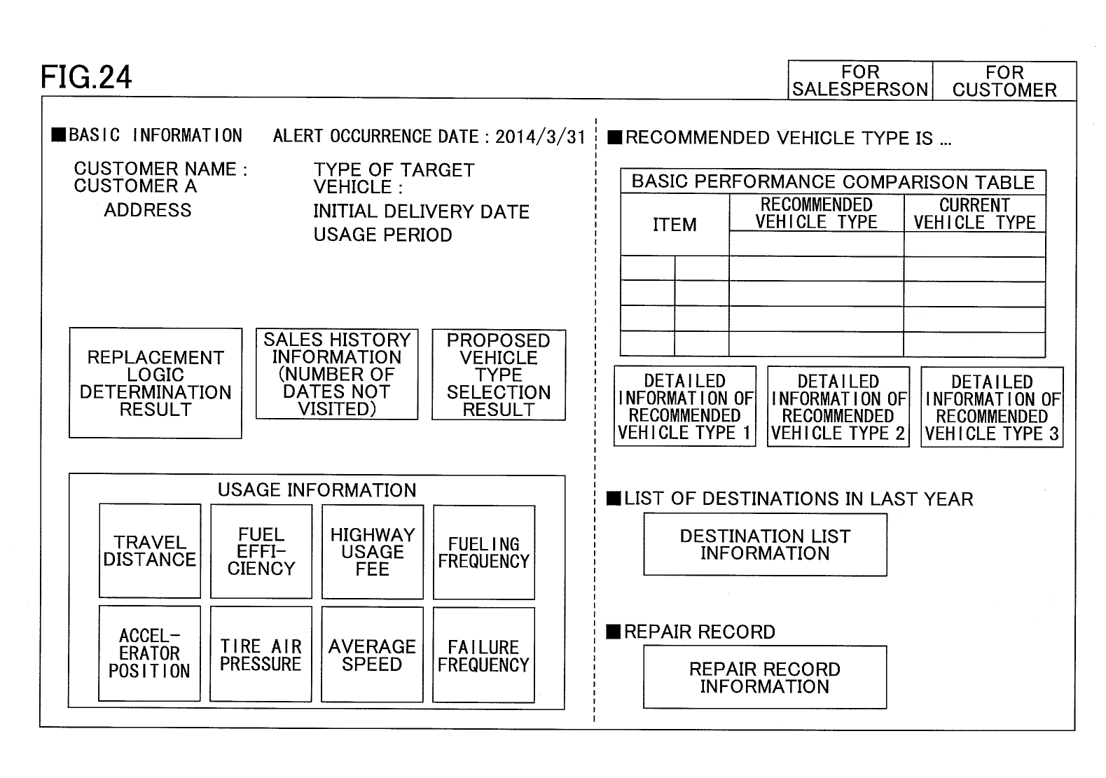

FIG. 24 illustrates an example of a sheet generated by the sheet generating unit 660, in a case where the support system 100 is applied when the management target is a vehicle.

As illustrated in FIG. 24, the sheet has the same configuration as the sheet (FIG. 20) generated when an image forming apparatus is the management target. Note that in the case of a vehicle, the maintenance center where maintenance is performed on the vehicle, and the sales store for selling vehicles often exist in the same place, and therefore only two types of sheets are generated, i.e., a sheet for the salesperson and a sheet for the customer.

### <3. Summary>

As it is clear from the above descriptions, the support system 100 can be applied in a similar manner even when the management target is changed.

According to one embodiment of the present invention, an information processing system, a server system, and an information processing apparatus are provided, which are capable of acquiring proposal support information for supporting sales activities, in replacing a target that is managed.

The information processing system, the server system, and the information processing apparatus are not limited to the specific embodiments described herein, and variations and modifications may be made without departing from the spirit and scope of the present invention.

The present application is based on and claims the benefit of priority of Japanese Priority Patent Application No. 2014-243649, filed on Dec. 2, 2014, the entire contents of which are hereby incorporated herein by reference.

What is claimed is:

1. An information processing apparatus comprising:
an acquiring unit configured to acquire information relating to a target used by a customer with which an administrator has not made contact for a predetermined period;
a determining unit configured to determine a target that matches a condition of replacement prediction, from among a plurality of the targets of which the relating information has been acquired by the acquiring unit;
a generating unit configured to generate proposal support information including the information relating to the target, with respect to the target that has been determined to match the condition by the determining unit; and
a report unit configured to send a report that enables acquisition of the proposal support information including the information relating to the target, to the administrator managing the target that has been determined to match the condition by the determining unit.

2. The information processing apparatus according to claim 1, wherein
the administrator includes at least one of a salesperson that performs sales activities with respect to the customer using the target and a maintenance person that performs maintenance on the target, and
the customer with which the administrator has not made contact includes a customer with which neither the salesperson nor the maintenance person has performed communication by dialogue.

3. The information processing apparatus according to claim 1, wherein
the determining unit determines that the target of which the relating information has been acquired by the acquiring unit matches the condition of replacement prediction, when the information relating to the target acquired by the acquiring unit matches all of a plurality of combinations of parameters and threshold ranges defined in advance as the condition of replacement prediction.

4. The information processing apparatus according to claim 3, wherein
the plurality of combinations of parameters and threshold ranges are determined according to an evaluation index determined in advance, by using information relating to a target that has been replaced by the customer among the targets managed by the administrator.

5. The information processing apparatus according to claim 1, wherein
the proposal support information includes at least
information relating to the customer using the target that has been determined to match the condition by the determining unit,
information indicating a usage record of the target,
information indicating a type of target appropriate for replacing the target, and
information indicating a failure record of the target.

6. The information processing apparatus according to claim 2, wherein
the report unit sends an alert including information regarding a storage destination, the storage destination storing data in which a list of the targets that have been determined to match the condition by the determining unit is recorded for each of the administrators.

7. The information processing apparatus according to claim 6, wherein
the report unit sends the alert addressed to the salesperson performing the sales activities in an area to which the customer, who is using the target that has been determined to match the condition by the determining unit, belongs.

8. The information processing apparatus according to claim 4, wherein
a fee is charged according to a determination result of the plurality of combinations of parameters and threshold ranges.

9. A server system including a plurality of server devices for implementing various functions of the server system, the server system comprising:
an acquiring unit configured to acquire information relating to a target used by a customer with which an administrator has not made contact for a predetermined period;
a determining unit configured to determine a target that matches a condition of replacement prediction, from among a plurality of the targets of which the relating information has been acquired by the acquiring unit;
a generating unit configured to generate proposal support information including the information relating to the target, with respect to the target that has been determined to match the condition by the determining unit; and
a report unit configured to send a report that enables acquisition of the proposal support information including the information relating to the target, to the administrator managing the target that has been determined to match the condition by the determining unit.

10. An information processing system comprising:
a server device; and
an information terminal communicatively connected to the server device, wherein
the server device includes
an acquiring unit configured to acquire information relating to a target used by a customer with which an administrator has not made contact for a predetermined period,
a determining unit configured to determine a target that matches a condition of replacement prediction, from among a plurality of the targets of which the relating information has been acquired by the acquiring unit,
a generating unit configured to generate proposal support information including the information relating to the target, with respect to the target that has been determined to match the condition by the determining unit, and
a report unit configured to send a report that enables acquisition of the proposal support information including the information relating to the target, to the administrator managing the target that has been determined to match the condition by the determining unit, and wherein
the information terminal includes
an output unit configured to read, from the server device, the proposal support information including the information relating to the target that has been determined to match the condition by the determining unit, the proposal support information being read based on the report sent by the report unit.
